(19) United States
(12) Patent Application Publication
(10) Pub. No.: US 2012/0113412 A1
(43) Pub. Date: May 10, 2012

(54) SPECTRUM MEASURING APPARATUS FOR MOVER

(75) Inventors: Shinya Kawamata, Gotemba-shi (JP); Ryuji Funayama, Yokohama-shi (JP); Yasuhiro Yoshida, Susono-shi (JP); Yasukata Yokochi, Susono-shi (JP); Masato Endo, Susono-shi (JP); Toshiki Kindo, Yokohama-shi (JP); Kenichi Kitahama, Nagoya-shi (JP)

(73) Assignee: TOYOTA JIDOSHA KABUSHIKI KAISHA, Toyota-shi (JP)

(21) Appl. No.: 13/322,056

(22) PCT Filed: May 29, 2009
(86) PCT No.: PCT/JP09/59912

§ 371 Date: Jan. 26, 2012

(51) Int. Cl. G01J 3/28

(52) U.S. Cl. 356/51

(57) ABSTRACT

Provided is a moveable spectrum measuring apparatus capable of improving discrimination precision of a measuring object on the basis of observation data from a spectrum sensor mounted on a movable apparatus such as a vehicle. A measuring object and a reference body are irradiated with ambient light. A spectrum acquiring device acquires measuring object data indicating the spectrum of the measuring object, and reference body data indicating the spectrum of the reference body to become a reference at the time when the spectrum of the measuring object is corrected. A spectrum converting device has reference body reflectivity data indicating the surface reflectivity of the reference body, and creates ambient light data indicating the spectrum of the ambient light, on the basis of the reference body reflectivity data and the reference body data. By using the ambient light data, the measuring object data is converted into measuring object reflectivity data indicating the surface reflectivity of the measuring object. On the basis of the measuring object reflectivity data, a discrimination device discriminates the measuring object.

### TECHNICAL FIELD

The present invention relates to a movable body spectrum measuring apparatus that is mounted on a movable body such as a vehicle, in particular, an automobile, and measures a spectrum of light received from a measuring object.

### BACKGROUND ART

In recent years, vehicles such as automobiles have been often provided with an apparatus that, as a drive assisting apparatus, recognizes the state of a pedestrian and a traffic light, which dynamically varies around the vehicle, and assists driving and decision making for the driver. Most such apparatuses take an image of the state of a traffic light, a pedestrian or the like by use of a CCD camera, processes the taken image in real time to recognize the state, and uses a recognized result for the above-mentioned assistance for driving. However, since the shape of the pedestrian generally varies depending on size, orientation or presence or absence of his/her belongings, it is difficult to correctly recognize the existence of the pedestrian on the basis of the shape obtained by the above-mentioned image processing.

Among techniques for grasping the state of a measuring object from optical characteristics of the measuring object, for example, a technique for using a spectrum sensor mounted in an artificial satellite, which is used for agronomical surveying of the globe, is known as described in Patent Document 1. In the spectrum sensor described in Patent Document 1, light received from each region of a measuring object is dispersed according to wavelength and the light intensity for each wavelength in each region is associated with the wavelength to measure the spectrum. In other words, an optical characteristic of each region of the measuring object is treated as a continuous spectrum for each wavelength.

As described above, in the spectrum sensor, since the intensity of each wavelength including an invisible light region is measured, optical characteristics of the measuring object are grasped on the basis of the intensity for each wavelength, and the measuring object can be discriminated utilizing such a property with higher accuracy. Thus, in recent years, such spectrum sensors have been mounted on vehicles such as automobiles, and adoption of the technique of recognizing and discriminating the state surrounding vehicles on the basis of spectrum data acquired through the spectrum sensors has been considered.

### PRIOR ART DOCUMENT

### Patent Document

Patent Document 1: Japanese Laid-Open Patent Publication No. 2006-145362

### SUMMARY OF THE INVENTION

### Problems that the Invention is to Solve

However, when such a spectrum sensor is mounted on a movable body such as a vehicle, light applied to the measuring object, that is, ambient light also includes sunlight as well as light reflected from buildings surrounding the vehicle, roads and the like on which the vehicle is operating, street lights, light emitted from the vehicle itself, light from different light sources and light through different transmitting media. For this reason, the spectrum of reflected light observed from a measuring object depends on not only the optical characteristics of the measuring object itself but also characteristics of the light applied to the measuring object, thereby possibly lowering the discrimination accuracy of the measuring object.

Accordingly, it is an objective of the present invention to provide a movable body spectrum measuring apparatus capable of improving the discrimination accuracy of a measuring object on the basis of observation data of a spectrum sensor mounted on a movable body such as a vehicle.

### Means for Solving the Problems

A movable body spectrum measuring apparatus according to the present invention includes a spectrum sensor mounted on a movable body and is capable of measuring wavelength information and light intensity information. The movable body spectrum measuring apparatus discriminates a measuring object around the movable body on the basis of a spectrum waveform of observed light detected by the spectrum sensor. The movable body spectrum measuring apparatus including a spectrum acquiring device for identifying a predetermined object from objects observed by the spectrum sensor. The spectrum acquiring device sets the identified object as a reference body for acquiring spectrum information.

With such a configuration for the movable body spectrum measuring apparatus, even when the movable body moves, the reference body exists in the detection range of the spectrum sensor at all times by identifying the predetermined object from the objects observed by the spectrum sensor and setting the identified object as the reference body. The spectrum information acquired based on such reference body becomes spectrum information according to environment surrounding the movable body at respective time. Therefore, the discrimination accuracy of the measuring object is improved by discriminating the measuring object on the basis of such spectrum information.

In accordance with one aspect of the present invention, the spectrum sensor is mounted such that at least a part of the movable body exists in a detection range of the measuring object.

Thus, a part of the movable body, which exists in the detection range of the spectrum sensor, can be set as a reference body. For this reason, for example, even when the movable body moves and the environment surrounding the movable body changes, the reference body is detected at the same position in the detection range of the spectrum sensor at all times. Therefore, the discrimination accuracy of the measuring object can be improved by identifying the measuring object on the basis of the spectrum information acquired on the basis of the same reference body at all times.

In accordance with one aspect of the present invention, the movable body is an automobile, and the spectrum sensor is mounted at a rear view mirror of the automobile to face the front such that a part of a hood of the automobile exists in the detection range of the measuring object.

Thus, the hood of the automobile can be selected as a reference body. By mounting the spectrum sensor at the rear view mirror, the forward field of view of the automobile driver is not blocked by the spectrum sensor.

In accordance with one aspect of the present invention, the spectrum acquiring device previously acquires spectrum information regarding paint on the hood, and acquires spectrum information regarding ambient light applied to the measuring object, using the acquired spectrum information as a reference.

As described above, the hood exists in the detection range of the spectrum sensor at all times. Thus, each time the spectrum of the measuring object is detected, the spectrum information on the paint of the hood is acquired, and using the spectrum information as a reference, the spectrum information on the ambient light can be acquired. That is, the spectrum information on the ambient light at the respective time can be acquired.

In accordance with one aspect of the present invention, the movable body is an automobile, and the spectrum sensor is mounted at a rear view mirror of the automobile to face the front such that a reflective member provided on a part of a windshield of the automobile exists in the detection range of the measuring object.

Thus, the reflective member provided at the windshield of the automobile can be selected as a reference body. Further, by mounting the spectrum sensor at the rear view mirror, the forward field of view of the automobile driver is not blocked by the spectrum sensor.

In accordance with one aspect of the present invention, the spectrum acquiring device previously acquires spectrum information on the reflective member, and acquires spectrum information on ambient light applied to the measuring object, using the acquired spectrum information as a reference.

As described above, the reflective member provided at a part of the windshield exists in the detection range of the spectrum sensor at all times. Thus, using, as a reference, the spectrum information on the reflective member, which is acquired each time the spectrum of the measuring object is detected, the spectrum information on the ambient light can be acquired. That is, the spectrum information on the ambient light at the respective time can be acquired.

In accordance with one aspect of the present invention, the movable body is an automobile, and the spectrum sensor is mounted at a rear view mirror of the automobile to face the front such that a part of a wiper of the automobile or a reflective member provided on a part of the wiper exists in the detection range of the measuring object.

Thus, the wiper of the automobile or the reflective member provided at a part of the wiper can be selected as a reference body. Further, by mounting the spectrum sensor at the rear view mirror, the forward field of view of the automobile driver is not blocked by the spectrum sensor.

In accordance with one aspect of the present invention, the spectrum acquiring device previously acquires spectrum information on the wiper or the reflective member, and acquires spectrum information on ambient light applied to the measuring object, using the acquired spectrum information as a reference.

As described above, the wiper or the reflective member provided at a part of the wiper exists in the detection range of the spectrum sensor at all times. Thus, using, as a reference, the spectrum information on the wiper or the reflective member, which is acquired each time the spectrum of the measuring object is detected, the spectrum information on the ambient light can be acquired. That is, the spectrum information on the ambient light at the respective time can be acquired.

In accordance with one aspect of the present invention, the movable body is an automobile, and the reference body set by the spectrum acquiring device is a traffic sign.

Thus, even when a part of the movable body does not exist in the detection range of the spectrum sensor, a traffic sign is set as a reference body. Further, since traffic signs frequently appear in the detection range of the spectrum sensor during movement of the automobile, a reference body is detected at high frequency and at each detection, the spectrum information on the ambient light can be acquired.

In accordance with one aspect of the present invention, the spectrum acquiring device previously acquires spectrum information on the traffic sign, and acquires spectrum information on ambient light applied to the measuring object, using the acquired spectrum information as a reference.

As described above, during movement of the automobile, traffic signs frequently appear in the detection range of the spectrum sensor. For this reason, each time a traffic sign exists in the detection range of the spectrum sensor, using the spectrum information on the traffic sign as a reference, the spectrum information on the ambient light can be acquired. That is, the spectrum information on the ambient light can be acquired at high frequency. Furthermore, since the spectrum information on traffic signs does not greatly change, the spectrum information on the ambient light can be stably acquired.

In accordance with one aspect of the present invention, the movable body is an automobile, and the reference body set by the spectrum acquiring device is a road.

Thus, even when a part of the movable body does not exist in the detection range of the spectrum sensor, the road can be set as a reference body. Further, since the automobile moves on the road, the detection position of the road as a reference body in the detection range of the spectrum sensor is easy to identify and the detection frequency is high. For this reason, the road as a reference body is detected at high frequency, and at each detection, the spectrum information on the ambient light can be acquired.

In accordance with one aspect of the present invention, the spectrum acquiring device previously acquires spectrum information on the road, and acquires spectrum information on ambient light applied to the measuring object, using the acquired spectrum information as a reference.

As described above, during movement of the automobile, the road frequently appears in the detection range of the spectrum sensor. Thus, each time the road is detected in the detection range of the spectrum sensor, using the spectrum information on the road as a reference, the spectrum information on the ambient light can be acquired. That is, the spectrum information on the ambient light can be acquired at high frequency. Furthermore, since the spectrum information on the road does not greatly change, the spectrum information on the ambient light can be stably acquired.

In accordance with one aspect of the present invention, the movable body is an automobile, and the reference body set by the spectrum acquiring device is a sky.

Thus, even when a part of the movable body does not exist in the detection range of the spectrum sensor, the sky can be set as a reference body. Furthermore, since the sky is often contained in the detection range of the spectrum sensor, the sky as a reference body is detected at high frequency, and at each detection, the spectrum information on the ambient light can be acquired.

In accordance with one aspect of the present invention, the spectrum acquiring device previously acquires spectrum information on the sky, and acquires spectrum information on ambient light applied to the measuring object, using the acquired spectrum information as a reference.

As described above, the sky is often contained in the detection range of the spectrum sensor. Thus, each time the sky is detected in the detection range of the spectrum sensor, using the spectrum information on the sky as a reference, the spectrum information on the ambient light can be acquired. That is, the spectrum information on the ambient light can be acquired at high frequency.

In accordance with one aspect of the present invention, a first spectrum sensor for detecting a spectrum of the measuring object and a second spectrum sensor for detecting a spectrum of the reference body are provided.

Thus, the spectrum of the measuring object and the spectrum of the reference body are detected by the different spectrum sensors. For example, as compared to a case where one spectrum sensor detects the spectrum of the measuring object and the spectrum of the reference body, the two spectrum sensor configuration adds to the flexibility for setting of the reference body. That is, the second spectrum sensor can be installed at a rear part, a side part or an upper part of the movable body. The increased flexibility of setting of the reference body improves the spectrum detection accuracy.

In accordance with one aspect of the present invention, the spectrum acquiring device acquires spectrum information regarding the ambient light on the basis of the acquired spectrum information on the reference body and known information on a surface of the reference body.

The spectrum information on the reference body is the spectrum of reflected light obtained by reflecting the ambient light applied to the reference body. In other words, the spectrum information on the reference body is the spectrum of light reflected at the light intensity at each wavelength of the ambient light according to optical characteristics of the surface of the reference body. Therefore, by previously acquiring such information on the surface of the reference body, which relates to light reflection, the spectrum information on the ambient light can be acquired on the basis of the spectrum obtained from the reference body.

In accordance with one aspect of the present invention, the spectrum acquiring device calculates the spectrum information on the ambient light by dividing the acquired spectrum information on the reference body by known surface reflectivity of the surface of the reference body.

The spectrum information on the reference body is the spectrum of the reflected light obtained by reflecting the ambient light applied to the reference body. In other words, the spectrum information on the reference body is the spectrum of light reflected at the light intensity at each wavelength of the ambient light according to the surface reflectivity of the reference body. Therefore, when the surface reflectivity of the reference body is previously measured, the spectrum information on the ambient light can be calculated at high accuracy by dividing the spectrum of the reference body by the surface reflectivity.

### BRIEF DESCRIPTION OF THE DRAWINGS

FIG. 1 is a block diagram showing the electrical configuration of a movable body spectrum measuring apparatus in accordance of each embodiment of the present invention to describe the basic principle of the apparatus;

FIG. 2 is a graph showing an example of a spectrum of a reference body;

FIG. 3 is a graph showing an example of a surface reflectivity of the reference body;

FIG. 4 is a graph showing an example of a spectrum of an ambient light;

FIG. 5 is a block diagram showing configuration adopted in first to sixth embodiments of the movable body spectrum measuring apparatus according to the present invention;

FIG. 6(a) is a diagram showing an installation position of a spectrum sensor according to the first embodiment;

FIG. 6(b) is a diagram showing a part of a detection range of the spectrum sensor according to the first embodiment;

FIG. 7 (a) is a diagram showing a part of the detection range of the spectrum sensor according to the second embodiment;

FIG. 7(b) is a diagram for describing a mechanism in which reflected light from a reflective member is incident on the spectrum sensor according to the second embodiment;

FIG. 8 is a diagram showing a part of the detection range of the spectrum sensor according to a third embodiment;

FIG. 9 is a diagram showing a part of the detection range of the spectrum sensor according to a fourth embodiment;

FIG. 10 is a diagram showing an installation position of the spectrum sensor according to a fifth embodiment;

FIG. 11 is a diagram showing a part of the detection range of the spectrum sensor according to the fifth embodiment;

FIG. 12 is a diagram showing a part of the detection range of the spectrum sensor according to a sixth embodiment;

FIG. 13 is a block diagram showing configuration of the movable body spectrum measuring apparatus according to seventh to ninth embodiments of the present invention;

FIG. 14 is a diagram showing a part of the detection range of the spectrum sensor according to the seventh embodiment;

FIGS. 15(a) shows a type of traffic sign;

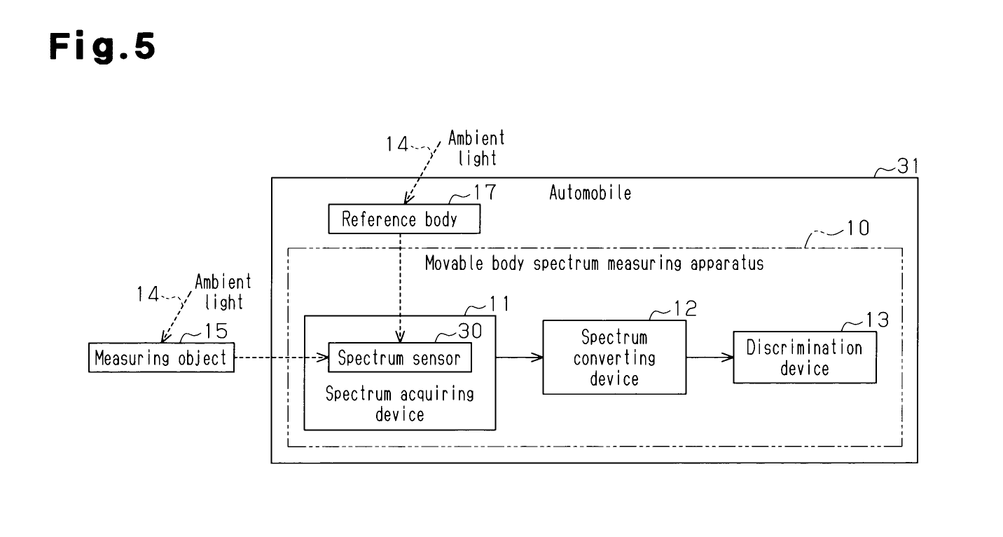

FIG. 5(b) is a graph showing relationship between the type of a traffic sign and its surface reflectivity;

FIG. 16(a) shows a type of a traffic sign;

FIG. 16(b) is a graph showing relationship between the type of a traffic sign and its surface reflectivity;

FIG. 17(a) shows a type of a traffic sign;

FIG. 17(b) is a graph showing relationship between the type of a traffic sign and its surface reflectivity;

FIG. 18 is a diagram showing a part of the detection range of the spectrum sensor according to an eighth embodiment;

FIG. 19 is a diagram showing a part of the detection range of the spectrum sensor according to a ninth embodiment;

FIG. 20 is a block diagram showing configuration of the movable body spectrum measuring apparatus according to tenth and eleventh embodiments of to the present invention;

FIG. 21 is a diagram showing a part of the detection range of the spectrum sensor according to the tenth embodiment;

FIG. 22 is a diagram showing a part of the detection range of the spectrum sensor according to the eleventh embodiment;

FIG. 23 is a block diagram showing configuration of the movable body spectrum measuring apparatus according to twelfth to fourteenth embodiments of the present invention;

FIG. 24(a) is a diagram showing an installation position of a second spectrum sensor according to the twelfth embodiment;

FIG. 24(b) is a diagram showing a part of the detection range of the second spectrum sensor according to the twelfth embodiment;

FIG. 25(a) is a diagram showing an installation position of the second spectrum sensor according to the thirteenth embodiment;

FIG. 25(b) is a diagram showing a part of the detection range of the second spectrum sensor according to the thirteenth embodiment;

FIG. 26 is a diagram showing an installation position of the second spectrum sensor according to the fourteenth embodiment;

FIG. 27 is a block diagram showing configuration of the movable body spectrum measuring apparatus according to fifteenth to seventeenth embodiments of the present invention;

FIG. 28 is a block diagram showing configuration of the movable body spectrum measuring apparatus according to eighteenth and nineteenth embodiments of the present invention;

FIG. 29 is a block diagram showing electrical configuration of the movable body spectrum measuring apparatus according to a twentieth embodiment of the present invention;

FIG. 30 is a block diagram showing electrical configuration of the movable body spectrum measuring apparatus according to a twenty-first embodiment of the present invention;

FIG. 31 is a diagram showing a part of the detection range of the spectrum sensor according to the twenty-first embodiment;

FIG. 32 is a diagram showing a part of the detection range of a spectrum sensor according to a modification of the twenty-first embodiment;

FIG. 33 is a block diagram showing electrical configuration of the movable body spectrum measuring apparatus according to a twenty-second embodiment of the present invention;

FIG. 34(a) is a diagram showing an installation position of the second spectrum sensor;

FIG. 34(b) is a diagram showing a part of the detection range of the second spectrum sensor according to the twenty-second embodiment;

FIG. 35 is a block diagram showing electrical configuration of the movable body spectrum measuring apparatus according to a twenty-third embodiment of the present invention; and

FIG. 36 is a diagram showing detection ranges of the first and second spectrum sensors in the twenty-third embodiment.

### MODE FOR CARRYING OUT THE INVENTION

### Basic Principle

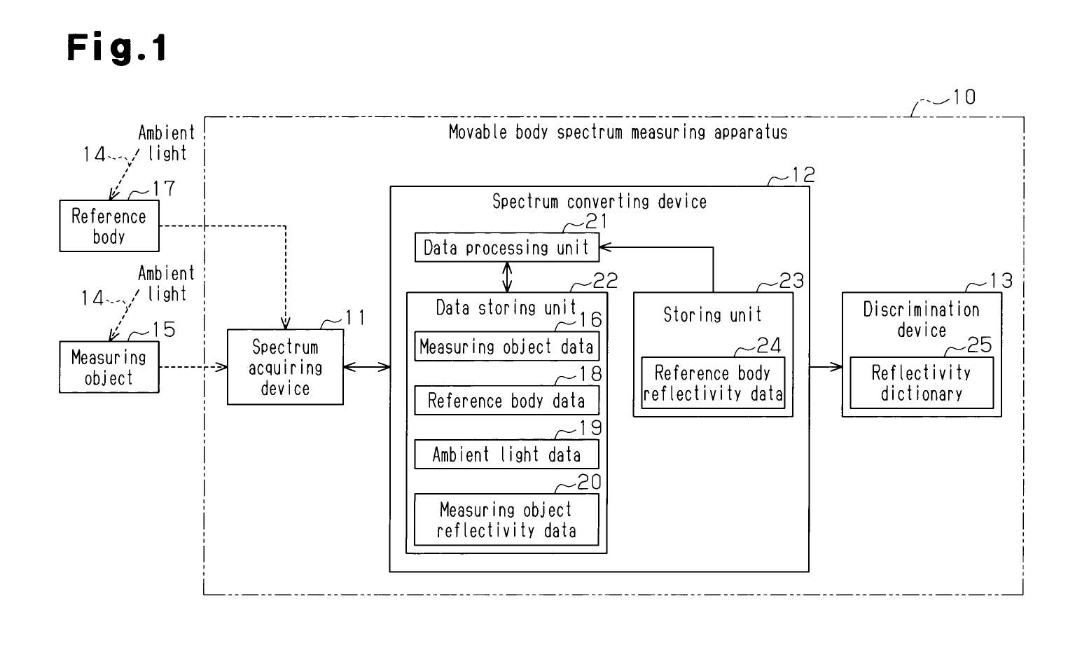

Prior to description of embodiments of a movable body spectrum measuring apparatus according to the present invention, a basic principle applicable to the embodiments will be described below with reference to FIGS. 1 to 4.

As shown in FIG. 1, a movable body spectrum measuring apparatus 10 roughly includes a spectrum acquiring device 11, a spectrum converting device 12 and a discrimination device 13.

Among them, the spectrum acquiring device 11 has at least one spectrum sensor (not shown). At each position in a detection range as a measuring object, the spectrum sensor detects reflected light from a measuring object 15 irradiated with ambient light 14, that is, a spectrum indicating the light intensity at each wavelength of observed light. The spectrum acquiring device 11 captures the spectrum detected at each position in the detection range by the spectrum sensor as measuring object data 16. In other words, the measuring object data 16 is data obtained by associating each position in the detection range of the spectrum sensor with the spectrum at the position. In the movable body spectrum measuring apparatus 10, a hyper spectrum sensor having a wide imageable bandwidth and a high resolution of a few nm to a dozens of nm is used as the spectrum sensor for detecting the spectrum of the measuring object 15.

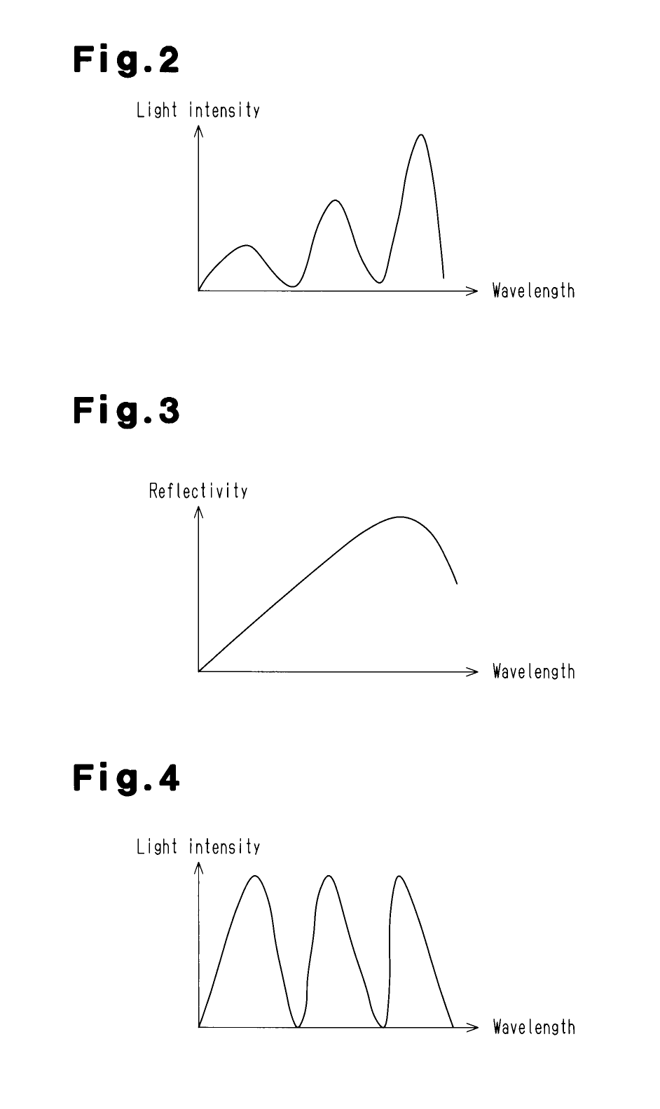

The spectrum acquiring device 11 also acquires a spectrum of reflected light from a reference body 17 irradiated with the same ambient light 14 as light applied to the measuring object 15 as reference body data 18. FIG. 2 is a graph showing the reference body data 18, representing wavelength as a horizontal axis and light intensity as a vertical axis. The reference body data 18 is also data obtained by associating the type of the reference body 17 with its spectrum. The spectrum of the reflected light from the reference body 17 is detected by the spectrum sensor for detecting the spectrum of the reflected light from the measuring object 15 or another spectrum sensor. The spectrum acquiring device 11 outputs the measuring object data 16 and the reference body data 18 to the spectrum converting device 12.

The spectrum converting device 12 includes a data processing unit 21, a data storing unit 22 and a storing unit 23, corrects each spectrum of the measuring object data 16 input from the spectrum acquiring device 11 and converts the corrected spectrum into measuring object reflectivity data 20 as optical characteristic data indicating the surface reflectivity at each position of the measuring object 15. Here, the data processing unit 21 stores the measuring object data 16 and the reference body data 18, which are input from the spectrum acquiring device 11, in a predetermined region of data storing unit 22.

Reference body reflectivity data 24 is stored in the storing unit 23 of the spectrum converting device 12. The reference body reflectivity data 24 indicates a ratio of the light intensity of light incident on the reference body 17 to the light intensity of the reflected light from the reference body 17, at each wavelength. FIG. 3 is a graph showing the reference body reflectivity data 24, representing wavelength as a horizontal axis and reflectivity as a vertical axis. The reference body reflectivity data 24 also indicates the surface reflectivity of the reference body 17 for each type of the reference body 17.

The reference body reflectivity data 24 is obtained by irradiating the reference body 17 with incident light having a predetermined spectrum, measuring the spectrum of the reflected light from the reference body 17 by use of a spectrometry device or the like, and dividing the light intensity of the measured reflected light by the light intensity of the incident light at each wavelength. That is, given that the light intensity of the incident light having a wavelength f is λf, the light intensity of the reflected light having the wavelength f is If, and the surface reflectivity with the wavelength f is Rf, the following equation (1) is satisfied.

Rf=If/λf (1)

The data processing unit 21 obtains the spectrum of the ambient light 14 applied to the measuring object 15 and the reference body 17 on the basis of the reference body data 18 stored in the data storing unit 22 and the reference body reflectivity data 24 stored in the storing unit 23. That is, since the incident light in the equation (1) corresponds to the ambient light 14, the spectrum of the ambient light 14 is represented by the following equation (2).

λf=If/Rf (2)

That is, the spectrum of the ambient light 14 is calculated by dividing the light intensity of the reflected light from the reference body 17 by the surface reflectivity of the reference body 17 at each wavelength. FIG. 4 is a graph showing the calculated spectrum of the ambient light 14, representing wavelength as a horizontal axis and light intensity as a vertical axis. The data processing unit 21 stores data indicating the calculated spectrum of the ambient light 14 as ambient light data 19 in a predetermined region of the data storing unit 22. By calculating the spectrum of the ambient light 14 on the basis of the previously measured surface reflectivity of the reference body 17 and the actually acquired spectrum of the reference body 17 in this manner, the spectrum of the ambient light 14 can be calculated with high accuracy.

Subsequently, the data processing unit 21 generates the measuring object reflectivity data 20 as data indicating the surface reflectivity at each position of the measuring object 15 on the basis of the measuring object data 16 and the ambient light data 19. The data processing unit 21 stores the generated measuring object reflectivity data 20 in a predetermined region of the data storing unit 22. As apparent from the above-mentioned equation (1), the measuring object reflectivity data 20 is calculated by dividing the light intensity of the measuring object 15 by the light intensity of the ambient light 14 at each wavelength. Then, the data processing unit 21 outputs the measuring object reflectivity data 20 stored in the predetermined region of the data storing unit 22 to the discrimination device 13. In other words, the spectrum converting device 12 is a device that generates the ambient light data 19 as data indicating the spectrum of the ambient light 14 on the basis of the reference body data 18 and the reference body reflectivity data 24, converts the measuring object data 16 into the measuring object reflectivity data 20 on the basis of the ambient light data 19 and the measuring object data 16, and outputs the measuring object reflectivity data 20 to the discrimination device 13.

Different objects have different surface reflectivities according to differences in physical properties. For this reason, an object has its own surface reflectivity and the object can be discriminated on the basis of the unique surface reflectivity.

The discrimination device 13 has a reflectivity dictionary 25. The reflectivity dictionary 25 is data obtained by associating the surface reflectivity with an object having the surface reflectivity. The discrimination device 13 stores the measuring object reflectivity data 20 input from the spectrum converting device 12 in a data storing unit (not shown) and discriminates the measuring object 15 with reference to the reflectivity dictionary 25.

Then, according to a discrimination result of the discrimination device 13, the movable body spectrum measuring apparatus 10 informs the type, shape, position and the like of the object located in the detection range of the spectrum sensor to, for example, the driver of the movable body to assist movement of the movable body. Such discrimination of the measuring object 15 is continuously performed at predetermined intervals.

Although various embodiments using the movable body spectrum measuring apparatus with the above-mentioned basic configuration will be described below, similar members are given to the same reference numerals and detailed description thereof is not repeated here.

The above-mentioned movable body spectrum measuring apparatus may be modified as follows.

That is, with the above-mentioned basic configuration, the spectrum of the ambient light 14 and the measuring object 15 are discriminated using the optical surface reflectivity of the measuring object 15 as an optical characteristic of the measuring object 15. However, the spectrum of the ambient light 14 and the measuring object 15 may be also discriminated, for example, on the basis of the optical surface absorptivity of the measuring object 15 as an optical characteristic of the measuring object 15.

### First Embodiment

Next, a first embodiment of the movable body spectrum measuring apparatus according to the present invention based on the above-mentioned principle will be described with reference to FIG. 5.

As shown in FIG. 5, in the movable body spectrum measuring apparatus 10 according to the first embodiment, the spectrum acquiring device 11 has one spectrum sensor 30, and the spectrums of the reflected light from the measuring object 15 and the reference body 17 are acquired by the single spectrum sensor 30.

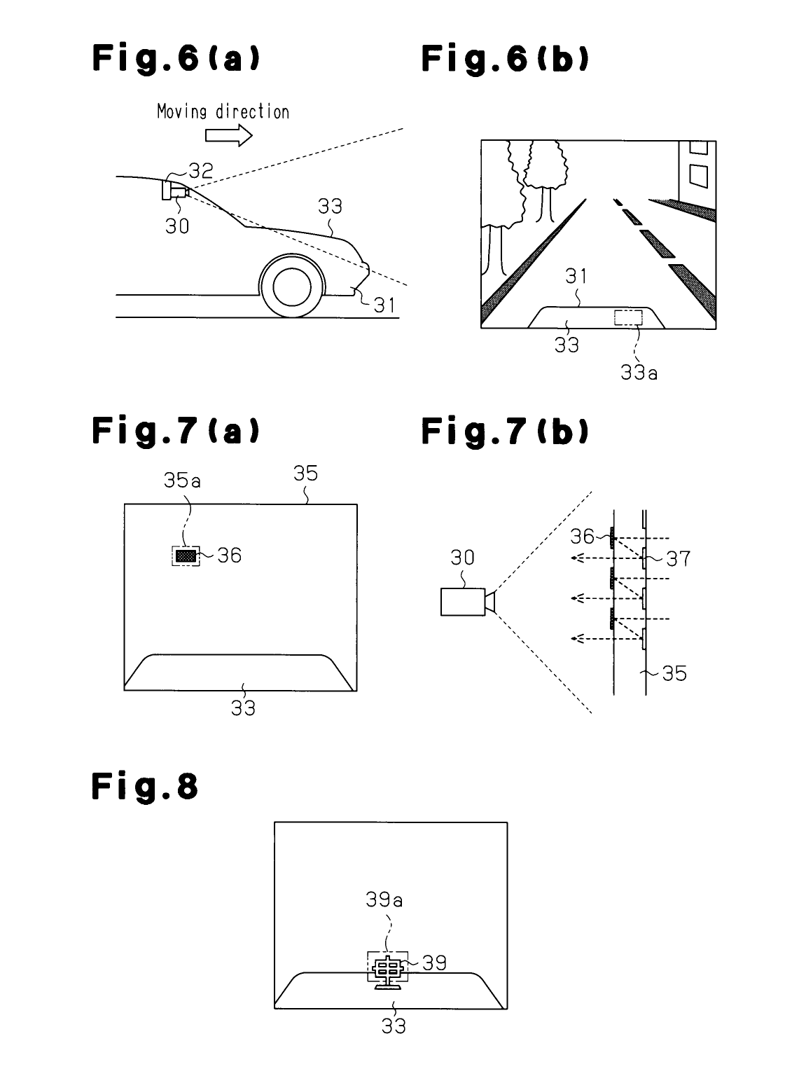

The spectrum sensor 30, as shown in FIG. 6(a), is provided at a rear view mirror 32 of an automobile 31 as the movable body and sets the front of the automobile 31 as the detection range. That is, the movable body spectrum measuring apparatus 10 assists forward movement of the automobile 31. By installing the spectrum sensor 30 at the rear view mirror 32, the spectrum sensor 30 is provided without blocking the field of view of the driver.

FIG. 6(b) is a diagram showing a part of the detection range of the spectrum sensor 30. As shown in the drawing, the spectrum sensor 30 is installed such that a hood 33 constituting the automobile 31 is contained in the detection range. That is, when the spectrum sensor 30 detects the spectrum of the reflected light from the measuring object 15, the spectrum of the reflected light from the hood 33 is detected at all times. In the first embodiment, as represented by a line formed by a long dash alternating with two short dashes in FIG. 6(b), a detection position corresponding to a part of the hood 33 is set as a detection position 33a for detecting the spectrum of the reference body 17. That is, in the first embodiment, this hood 33 is set as the reference body 17. In doing so, even when the automobile 31 moves, the same reference body 17 can be contained in the detection range of the spectrum sensor 30 at all times. Further, even when the ambient light 14 varies, the spectrum of the reflected light is detected from the same reference body 17 at all times.

The spectrum acquiring device 11 outputs the measuring object data 16 as data indicating the spectrum of the reflected light at each position in the detection range of the spectrum sensor 30 to the spectrum converting device 12. The spectrum acquiring device 11 also extracts the spectrum of the reflected light, which corresponds to the detection position 33a of the reference body 17, from the measuring object data 16 and outputs data indicating the spectrum as the reference body data 18 to the spectrum converting device 12.

The storing unit 23 of the spectrum converting device 12 in the first embodiment stores data on the surface reflectivity of the hood 33, that is, data regarding the surface reflectivity of a paint applied to the hood 33, as the reference body reflectivity data 24, therein. The spectrum converting device 12 calculates the spectrum of the ambient light 14 on the basis of the reference body data 18 and the reference body reflectivity data 24.

In the first embodiment, with the above-mentioned configuration, the measuring object data 16 and the reference body data 18 are acquired, and on the basis of the data and the reference body reflectivity data 24 indicating the surface reflectivity of the hood 33, the spectrum of the ambient light 14 is calculated.

As described above, the movable body spectrum measuring apparatus in accordance with the first embodiment can achieve following advantages.

(1) The single spectrum sensor 30 acquires the measuring object data 16 and the reference body data 18. Thereby, the minimum number of spectrum sensor 30 can assist movement of the automobile 31 in a direction containing the detection range of the spectrum sensor 30.

(2) The spectrum sensor 30 is installed such that the hood 33 constituting the automobile 31 is contained in the detection range at all times. Thereby, it is possible to select the hood 33 at all times as the reference body 17 that acts as a reference at the time when the measuring object data 16 is corrected (converted). As a result, in both cases where the automobile 31 moves and where the ambient light 14 varies, the spectrum of the ambient light 14 can be calculated on the basis of the spectrum of the reflected light from the same reference body 17 at all times.

(3) Therefore, since the spectrum of the ambient light 14 is calculated at respective time and the measuring object 15 is discriminated on the basis of the calculated spectrum of the ambient light 14, the discrimination accuracy of the measuring object can be improved.

(4) The spectrum sensor 30 sets the front of the automobile 31 as the detection range. Thereby, forward movement of the automobile 31 can be assisted.

(5) Similarly, the spectrum sensor 30 is provided at the rear view mirror 32. Thus, the spectrum sensor 30 can be provided without blocking the field of view of the automobile driver.

### Second Embodiment

Next, a second embodiment of the movable body spectrum measuring apparatus according to the present invention will be described with reference to FIG. 7. Since the second embodiment has the same basic configuration as the first embodiment except for the reference body 17, only the differences will be described in detail below.

FIG. 7(a) is a diagram showing a part of the detection range of the spectrum sensor 30 in the second embodiment. As shown in FIG. 7(a), in the second embodiment, as in the first embodiment, the spectrum sensor 30 that sets the front of the automobile 31 as the detection range is installed at the rear view mirror 32. A reflective member 36 as the reference body 17 is attached to a windshield 35 of the automobile 31. In the second embodiment, as represented by a line formed by a long dash alternating with two short dashes in FIG. 7(a), a detection position corresponding to the reflective member 36 is set as a detection position 35a for detecting the spectrum of the reflected light from the reference body 17. The reflective member 36 has preferably a uniform reflectivity with respect to each wavelength and is manufactured, for example, by enclosing liquid or powder barium sulfate in quartz glass.

The ambient light 14 applied to the measuring object 15 is light incident from the outside into the inside of the automobile 31. For this reason, at the reflective member 36 attached to the windshield 35, the ambient light 14 reflected from the reflective member 36 is applied to the outside of the automobile. In other words, when the reflective member 36 is merely attached to the windshield 35, it is difficult that the spectrum sensor 30 provided at the rear view mirror 32 detects the spectrum of the reflected light, that is, the spectrum of the reflected light from the reference body 17.

Thus, in the second embodiment, as shown in FIG. 7(b), on the inner side of the windshield 35, the plurality of reflective members 36 are arranged at predetermined intervals. On the outer side of the windshield 35, a plurality of mirror members 37 for allowing the reflected light from the reflective members 36 to pass through a gap between the reflective members 36 and letting the light into the spectrum sensor 30 are arranged.

In this manner, the spectrum of the ambient light 14 reflected from the reflective member 36 as the reference body 17, that is, the spectrum of the reflected light from the reference body 17 is reflected again from the mirror members 37, passes through the gap between the reflective members 36 and is incident on the spectrum sensor 30. Thereby, even when the reflective member 36 attached to the windshield 35 is used as the reference body 17, the spectrum sensor 30 installed at the rear view mirror 32 can detect the spectrum of the reflected light from the reference body 17. Furthermore, since the reflective surface that reflects the ambient light 14 is arranged on the inner side of the automobile 31, the surface is unlikely to be influenced by dusts and climate, and therefore, the spectrum of the reflected light from the reference body 17 can be measured more correctly. Then, the spectrum acquiring device 11 acquires the spectrum corresponding to the detection position 35a of the reference body 17 from the measuring object data 16, and outputs the spectrum as the reference body data 18 to the spectrum converting device 12.

The storing unit 23 of the spectrum converting device 12 in the second embodiment stores data regarding the surface reflectivity of the reflective member 36 as the reference body reflectivity data 24 therein.

As described above, the movable body spectrum measuring apparatus in the second embodiment can achieve a following advantage in addition to the advantages (1) to (5) in the first embodiment.

(6) The reflective surface of the reference body 17 can be arranged on the inner side of the automobile 31. Thus, for example, as compared to the case where the reflective surface is arranged on the outer side, the surface is less likely to be influenced by dusts and climate. Therefore, the spectrum of the reflected light from the reference body 17 can be measured more correctly.

### Third Embodiment

Next, a third embodiment of the movable body spectrum measuring apparatus according to the present invention will be described with reference to FIG. 8. Since the third embodiment has the same basic configuration as the first embodiment except for the reference body 17, only differences will be described in detail below.

FIG. 8 is a diagram showing a part of the detection range of the spectrum sensor 30 in the third embodiment. As shown in FIG. 8, a emblem 39 is vertically arranged on the hood 33 of the automobile 31 as the movable body in the third embodiment. In the third embodiment, a detection position corresponding to the emblem 39 is set as a detection position 39a for detecting the spectrum of the reference body 17.

Data regarding the surface reflectivity of the emblem 39 as the reference body reflectivity data 24 is stored in the storing unit 23 of the spectrum converting device 12 in the third embodiment.

As described above, the movable body spectrum measuring apparatus in the third embodiment can also achieve the advantages (1) to (5) in the first embodiment.

The third embodiment may be modified as follows.

The emblem in the third embodiment is vertically arranged on the hood 33. However, the emblem is not necessarily arranged on the hood 33 vertically and only needs to be provided at some place on the hood 33.

The emblem may be provided with the above-mentioned reflective member 36. In this case, although the position corresponding to the emblem is a detection position of the reference body 17, data regarding the reflectivity of the reflective member 36 as the reference body reflectivity data 24 is stored in the storing unit 23 of the spectrum converting device 12.

### Fourth Embodiment

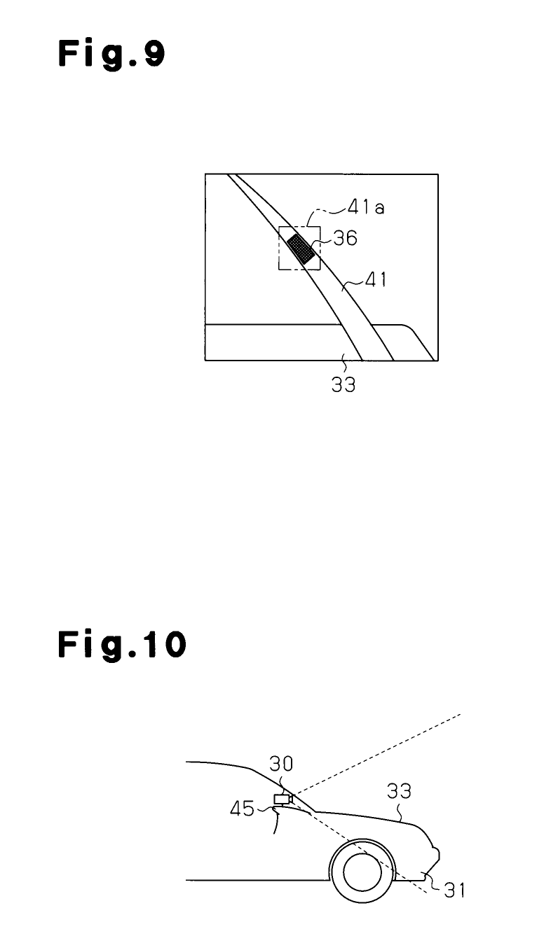

Next, a fourth embodiment of the movable body spectrum measuring apparatus according to the present invention will be described with reference to FIG. 9. Since the fourth embodiment has the same basic configuration as the first embodiment except for the reference body 17, only differences will be described in detail below.

FIG. 9 is a diagram showing a part of the detection range of the spectrum sensor 30 in the fourth embodiment. As shown in FIG. 9, the automobile 31 as the movable body has a wiper 41 for wiping water droplets and the like on the windshield 35. The wiper 41 is coupled to a rotational shaft (not shown) provided at the automobile 31 at one end and reciprocatingly rotates about the rotational shaft. In the movable body spectrum measuring apparatus 10 in the fourth embodiment, a part of the wiper 41 is regarded as the reference body 17. The wiper 41 mounted on the automobile often has a surface of black or black-like color. Black color has a high optical absorptivity and an object having a black surface tends to have a low optical reflectivity. For this reason, even when such object is irradiated with the ambient light 14 having a sufficient light intensity, the light intensity of the reflected light can become very small. Thus, in the fourth embodiment, the above-mentioned reflective member 36 is attached to a part of the wiper 41 and the reflective member 36 is used as the reference body 17. By providing the reflective member 36, even a member having a high optical absorptivity, that is, a small optical reflectivity, can function as the reference body 17.

The spectrum acquiring device 11 in the fourth embodiment is electrically connected to a wiper control device (not shown) for controlling the rotational operation of the wiper 41. When detecting the spectrum of the measuring object 15, the spectrum acquiring device 11 acquires information on the position of the wiper 41 from the wiper control device, and as represented by a line formed by a long dash alternating with two short dashes in FIG. 9, sets the position where the part of the wiper 41, to which the reflective member 36 is attached, reciprocates as a detection position 41a for detecting the spectrum of the reference body 17. Then, the spectrum acquiring device 11 detects the spectrum of the reflected light of the wiper 41 (the reflective member 36) from the measuring object data 16 on the basis of the detection position 41a, and outputs data indicating the detected spectrum as the reference body data 18 to the spectrum converting device 12.

Data regarding the reflectivity of the reflective member 36 as the reference body reflectivity data 24 is stored in the storing unit 23 of the spectrum converting device 12 in the fourth embodiment.

As described above, the movable body spectrum measuring apparatus in the fourth embodiment can achieve following advantages in addition to the advantages (1) to (5) in the first embodiment.

(7) Even when a member moving in the detection range of the spectrum sensor 30, such as the wiper 41, is used as the reference body 17, the spectrum of the reflected light from the reference body 17 can be reliably acquired by acquiring the position of the reference body 17 in detecting the spectrum of the measuring object 15 and detecting the spectrum at the position of the measuring object data 16.

(8) Even an object of a color having a low optical reflectivity, such as the wiper 41, the object can function as the reference body 17 by attaching the reflective member 36.

The fourth embodiment may be modified as follows.

Although the reflective member 36 is attached to the wiper 41 and is used as the reference body 17 in the fourth embodiment, when the color of the wiper 41 has a high reflectivity, the wiper itself without the reflective member 36 may be set as the reference body 17. At this time, data regarding the surface reflectivity of the wiper 41 as the reference body reflectivity data 24 is stored in the storing unit 23 of the spectrum converting device 12.

The first to fourth embodiments may be modified as follows.

In the first to fourth embodiments, when the spectrum sensor 30 is provided at the rear view mirror 32 of the automobile 31 as the movable body, the hood 33 of the automobile 31 (the first embodiment), the reflective member 36 attached to the windshield 35 (the second embodiment), the emblem 39 (the third embodiment) and the reflective member 36 attached to the wiper 41 (the fourth embodiment) are structural members of the automobile 31, which are contained in the detection range. However, the structural members of the automobile 31 are not limited to these as long as they are contained in the detection range of the spectrum sensor 30, and for example, may be the reflective member 36 attached to the hood 33 or a guide pole that is provided at a left end of a head of the automobile 31 and acts as a mark indicating the position of the left end while the driver is driving the automobile 31.

### Fifth Embodiment

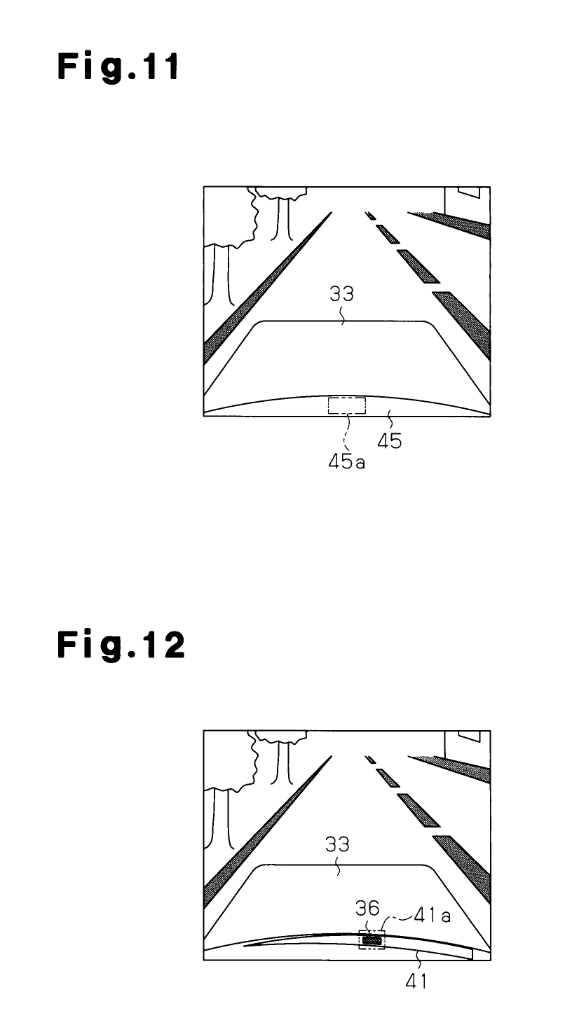

Next, a fifth embodiment of the movable body spectrum measuring apparatus according to the present invention will be described with reference to FIGS. 10 and 11. Since the fifth embodiment has the same basic configuration as the first embodiment, only differences will be described in detail below.

FIG. 10 is a diagram showing the installation position of the spectrum sensor 30 in the fifth embodiment. As shown in FIG. 10, the spectrum sensor 30 in the fifth embodiment sets the front of the automobile 31 to the movable body as the detection range and is installed on an instrument panel 45.

FIG. 11 is a diagram showing a part of the detection range of the spectrum sensor 30 thus installed. As shown in the drawing, the spectrum sensor 30 in the fifth embodiment is installed such that the instrument panel 45 constituting the automobile 31 is contained in the detection range. That is, when the spectrum sensor 30 detects the spectrum of the reflected light from the measuring object 15, the spectrum of reflected light from the instrument panel 45 is detected at all times. In the fifth embodiment, as represented by a line formed by a long dash alternating with two short dashes in FIG. 11, a position corresponding to a part of the instrument panel 45 is set as a detection position 45a for detecting the spectrum of the reference body 17.

Data regarding the surface reflectivity of the instrument panel 45 as the reference body reflectivity data 24 is stored in the storing unit 23 of the spectrum converting device 12 in the fifth embodiment.

As described above, the movable body spectrum measuring apparatus in the fifth embodiment can achieve the advantages (1) to (5) in the first embodiment and the advantage (6) in the second embodiment.

When the color of the instrument panel 45 is black or black-like color having a low reflectivity, the reflective member 36 can be attached to the detection position. In this case, data regarding the reflectivity of the reflective member 36 as the reference body reflectivity data 24 is stored in the storing unit 23 of the spectrum converting device 12. With such a configuration, the advantage (7) of the fourth embodiment can be achieved.

### Sixth Embodiment

Next, a sixth embodiment of the movable body spectrum measuring apparatus according to the present invention will be described with reference to FIG. 12. Since the sixth embodiment has the same basic configuration as the fifth embodiment, only differences will be described in detail below.

FIG. 12 is a diagram showing a part of the detection range of the spectrum sensor 30 in the sixth embodiment. As shown in FIG. 12, the spectrum sensor 30 in the sixth embodiment is installed such that the wiper 41 (during non-operation) constituting the automobile 31 is contained in the detection range. That is, during non-operation of the wiper 41, when the spectrum sensor 30 detects the spectrum of the reflected light from the measuring object 15, the spectrum of the reflected light from the wiper 41 is detected at all times. In the sixth embodiment, as represented by a line formed by a long dash alternating with two short dashes in FIG. 12, a part of the wiper 41 is set as the detection position 41a for detecting the spectrum of the reference body 17. Then, for the above-mentioned reason, the reflective member 36 is attached to a part of the wiper 41 located at the detection position 41a.

Data regarding the reflectivity of the reflective member 36 as the reference body reflectivity data 24 is stored in the storing unit 23 of the spectrum converting device 12 in the sixth embodiment.

As described above, the movable body spectrum measuring apparatus in the sixth embodiment can achieve the advantages (1) to (5) in the first embodiment and the advantage (7) in the fourth embodiment.

The fifth and sixth embodiments may be modified as follows.

In the fifth and sixth embodiments, when the spectrum sensor 30 is provided on the instrument panel 45 of the automobile 31 as the movable body, the instrument panel 45 (the fifth embodiment) and the reflective member 36 attached to the wiper 41 (the sixth embodiment) are structural members of the automobile 31, which are contained in the detection range. However, the structural members of the automobile 31, which are contained in the detection range of the spectrum sensor 30, are not limited to these and for example, may be the hood 33.

### Seventh Embodiment

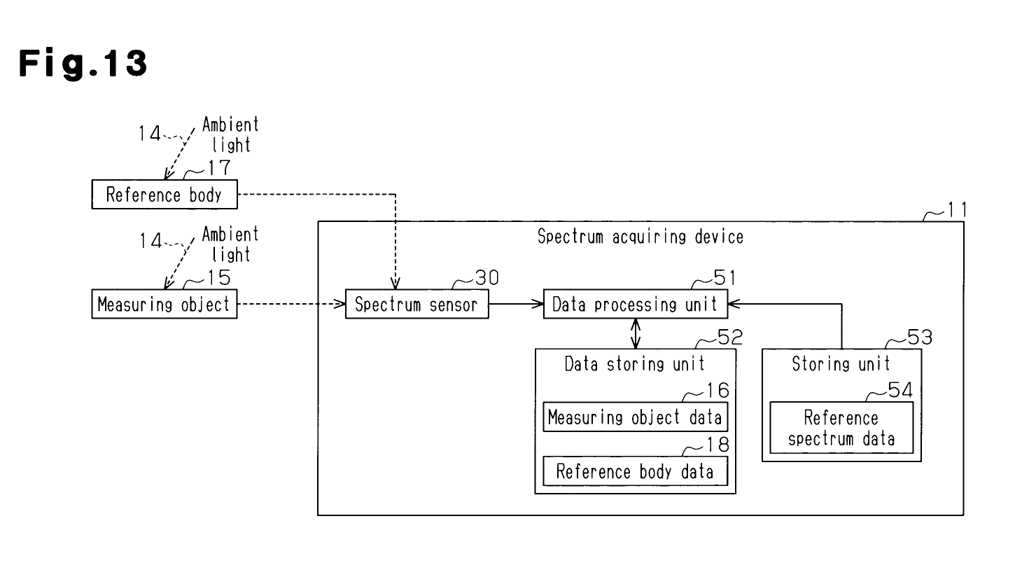

Next, a seventh embodiment of the movable body spectrum measuring apparatus according to the present invention will be described with reference to FIGS. 13 to 17. In the seventh embodiment, a part of the movable body is not contained in the detection range of the spectrum sensor and a specified object around the movable body is used as a reference body. Since the basic configuration of the movable body spectrum measuring apparatus in the seventh embodiment is the same as the configuration shown in FIG. 1, only differences will be described in detail below.

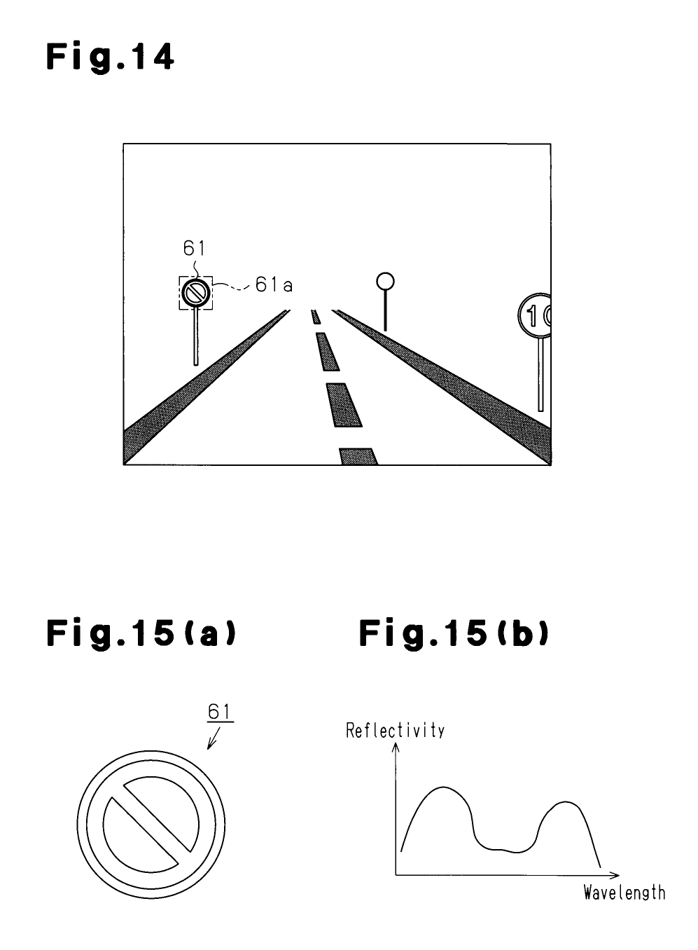

FIG. 13 is a block diagram showing configuration of the spectrum acquiring device in the seventh embodiment and FIG. 14 shows a part of the detection range of the spectrum sensor 30 in the seventh embodiment.

First, as shown in FIG. 13, the spectrum acquiring device 11 includes one spectrum sensor 30, a data processing unit 51, a data storing unit 52, and a storing unit 53.

As shown in FIG. 14, the spectrum sensor 30 in the seventh embodiment sets the front of the automobile 31 as the movable body as the detection range, and a part of the automobile 31 is not contained in the detection range. The spectrum sensor 30 detects the spectrum of the reflected light from the measuring object 15 irradiated with the ambient light 14. The data processing unit 51 captures data indicating the spectrum of the reflected light from the measuring object 15, which is detected by the spectrum sensor 30, as the measuring object data 16, and stores the data in a predetermined region of the data storing unit 52.

Reference body spectrum data 54 is stored in the storing unit 53 of the spectrum acquiring device 11. The reference body spectrum data 54 is data obtained by associating a specified object that can act as the reference body 17 with the spectrum of the reflected light, which is obtained by irradiating the specified object with various ambient light with a known spectrum. In the seventh embodiment, a traffic sign is selected as the specified object that can act as the reference body 17. In other words, the reference body spectrum data 54 in the seventh embodiment is data obtained by associating the spectrum of the reflected light from the traffic sign, which is obtained when the traffic sign is irradiated with various ambient light, with the traffic sign.

As represented by a line formed by a long dash alternating with two short dashes in FIG. 14, the data processing unit 51 extracts a detection position 61a, at which a spectrum that is substantially equal to the spectrum indicated by the reference body spectrum data 54 is detected, on the basis of the measuring object data 16 stored in the data storing unit 52 and the reference body spectrum data 54, and acquires the spectrum of the reflected light at the detection position 61a from the measuring object data 16. The data processing unit 51 reads a traffic sign 61 as the traffic sign corresponding to the acquired spectrum from the reference body spectrum data 54 and sets the traffic sign 61 as the reference body 17. The data processing unit 51 generates the reference body data 18 as data obtained by associating the traffic sign 61 as the reference body 17 with the spectrum acquired at the detection position 61a of the measuring object data 16, and stores the data in a predetermined region of the data storing unit 52. The data processing unit 51 outputs the measuring object data 16 and the reference body data 18 that are stored in the data storing unit 52 to the spectrum converting device 12.

With such a configuration, even when at least a part of the movable body is not contained in the detection range of the spectrum sensor 30, the specified object around the movable body can be set as the reference body 17. Furthermore, since the traffic sign as a standardized object is selected as the specified object, the surface reflectivity of the reference body 17 does not vary greatly even if the automobile 31 moves. In addition, since the traffic sign often appears during movement of the automobile 31, the spectrum of the reference body 17 can be detected with high frequency by setting the traffic sign as the reference body.

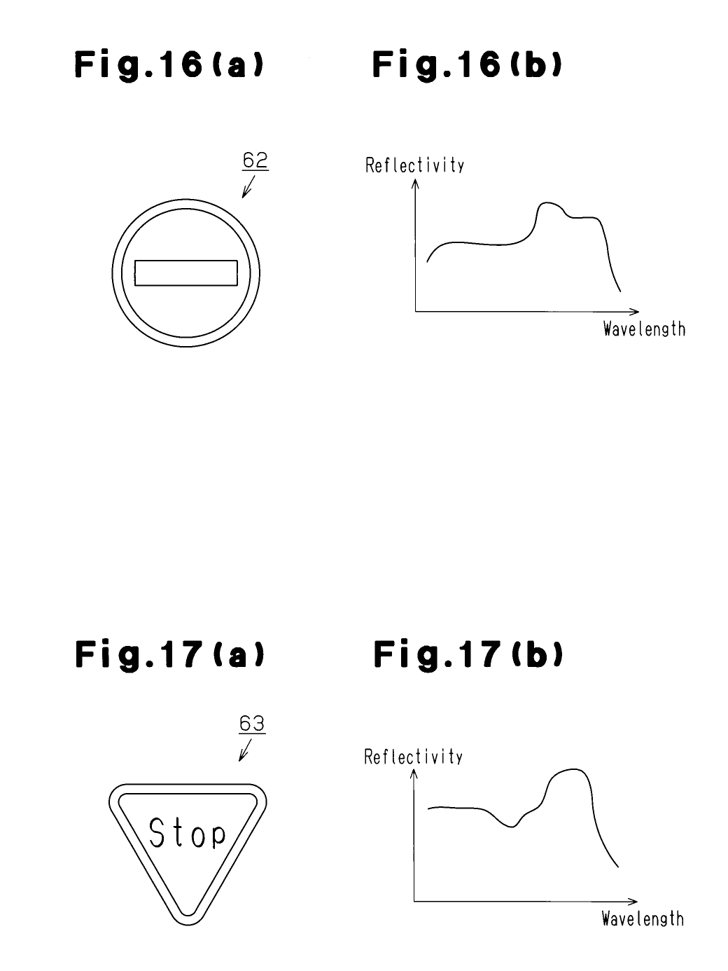

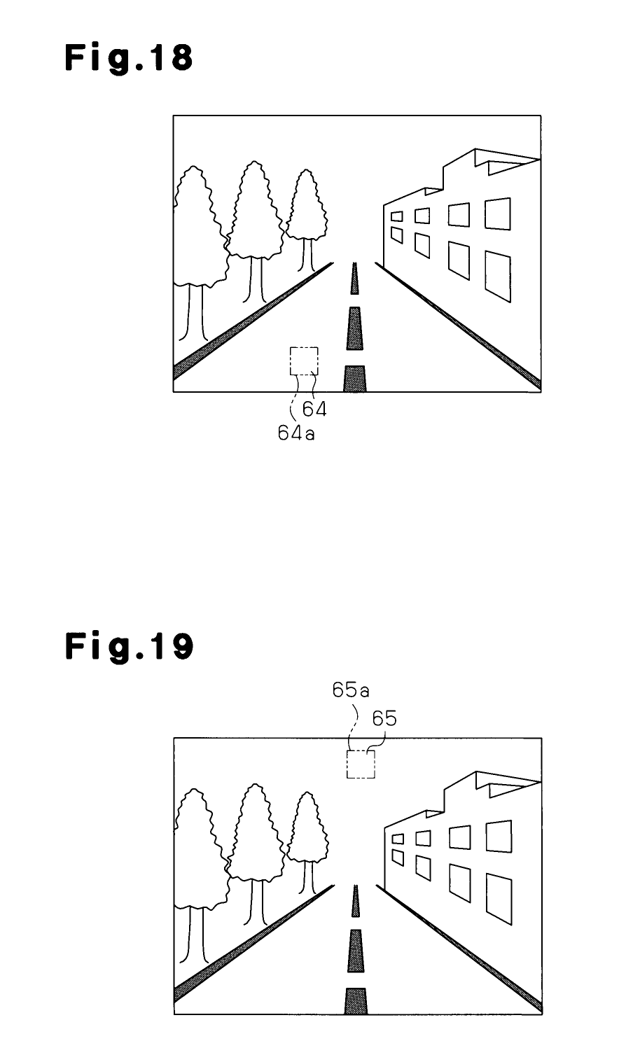

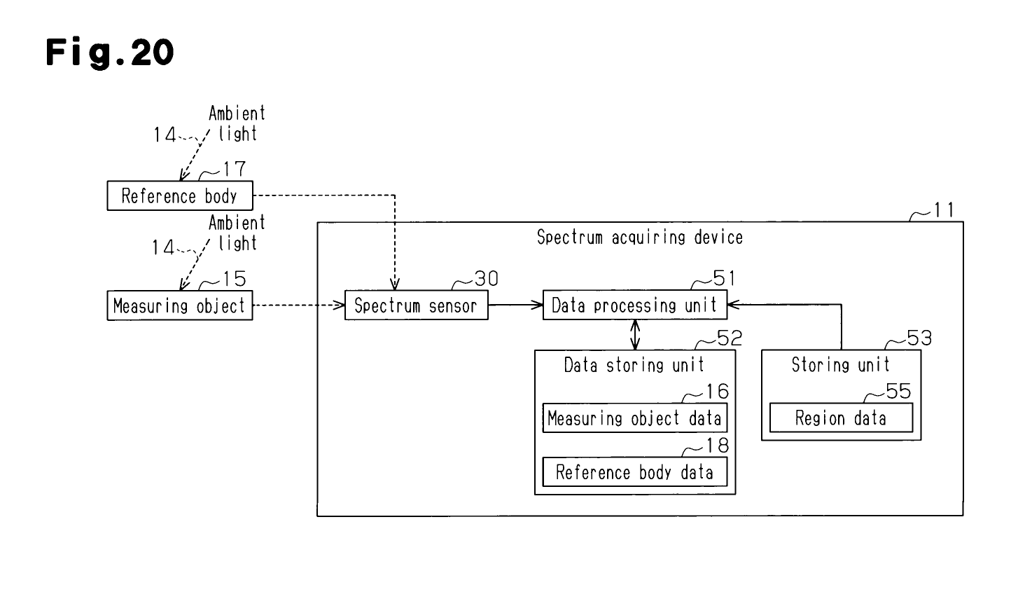

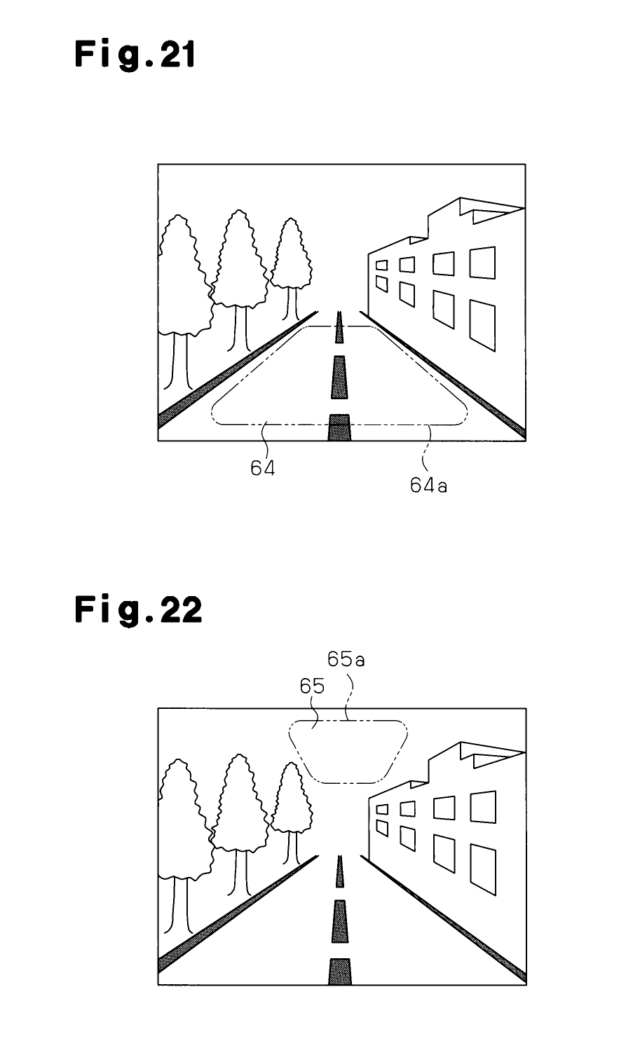

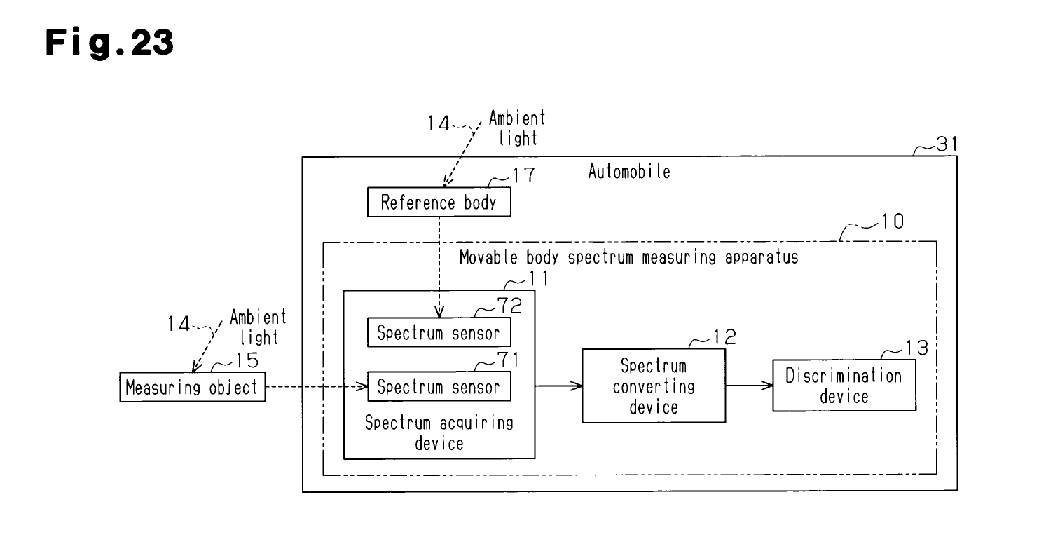

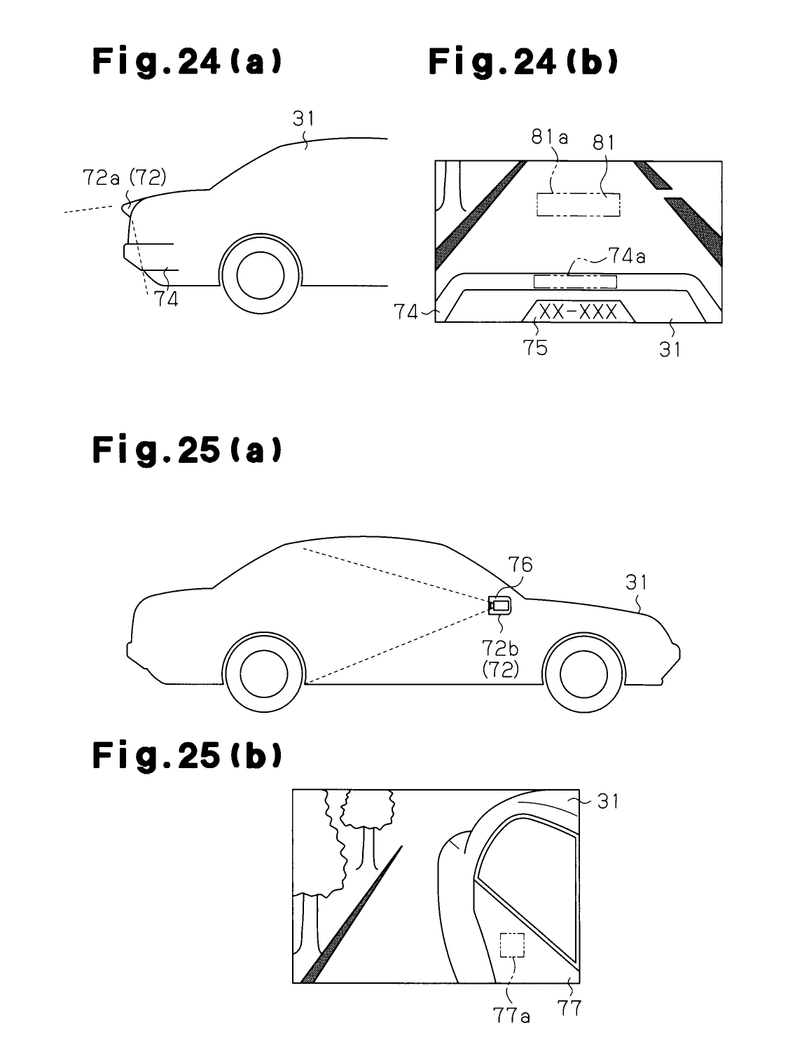

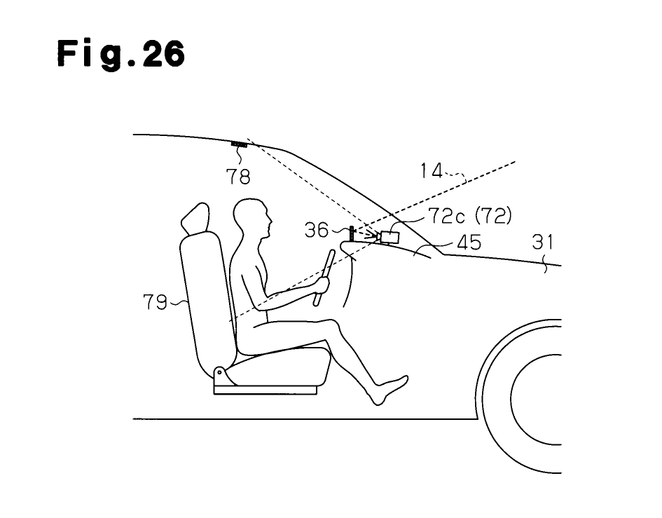

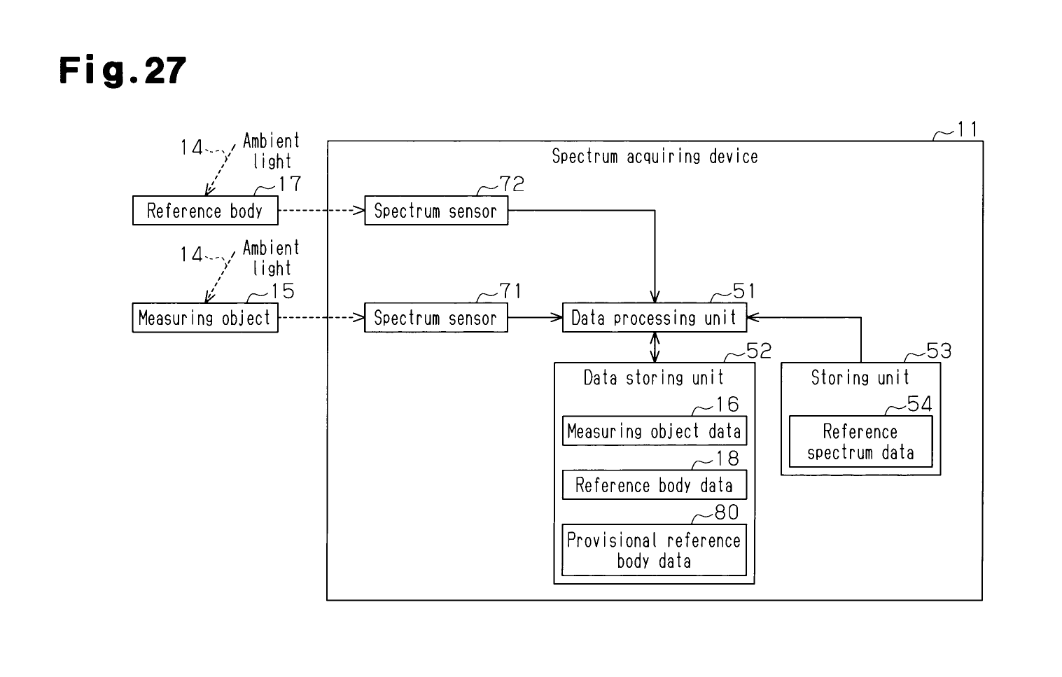

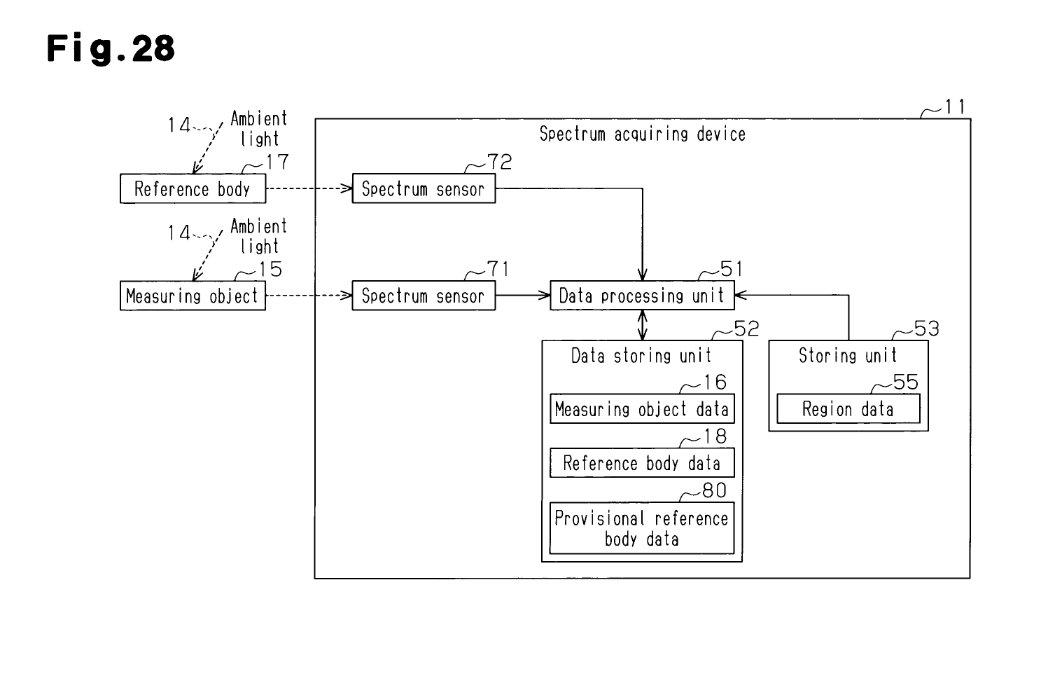

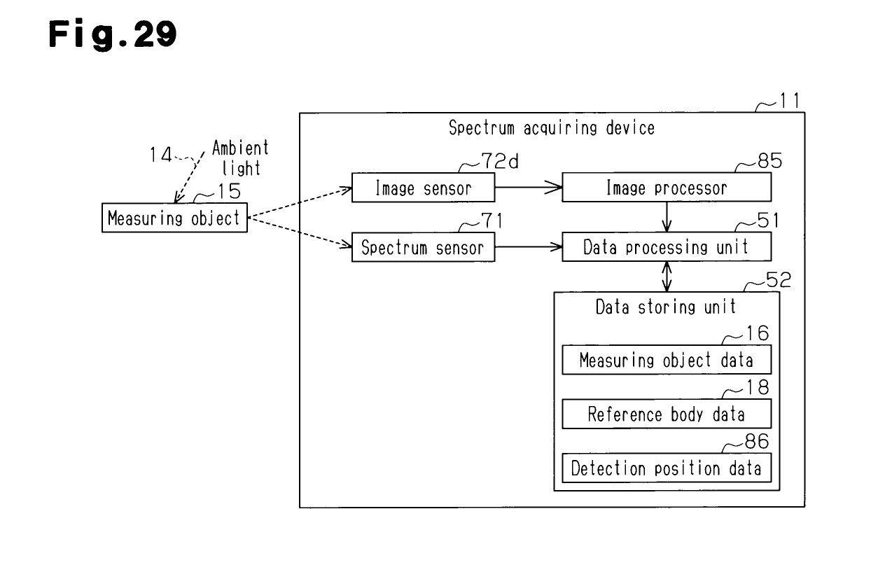

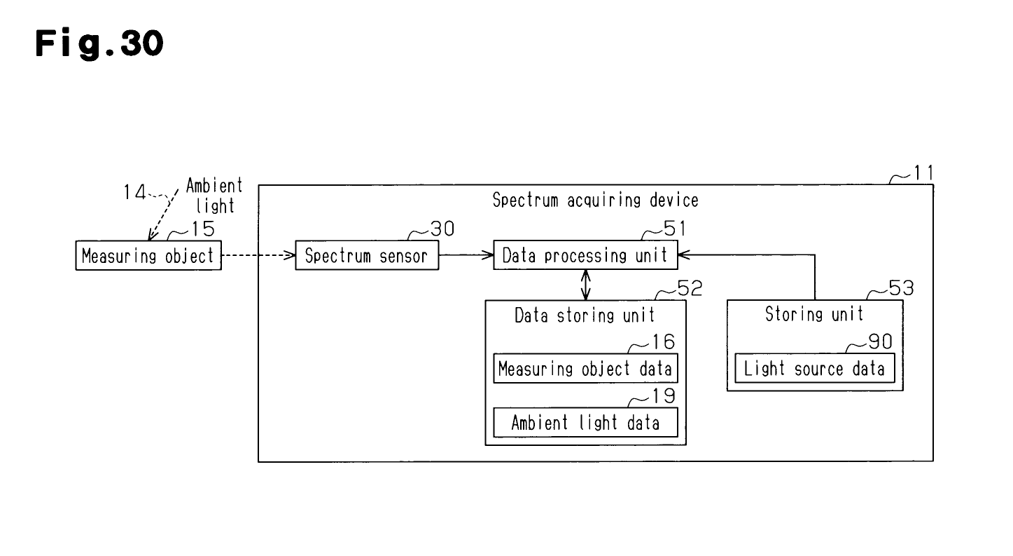

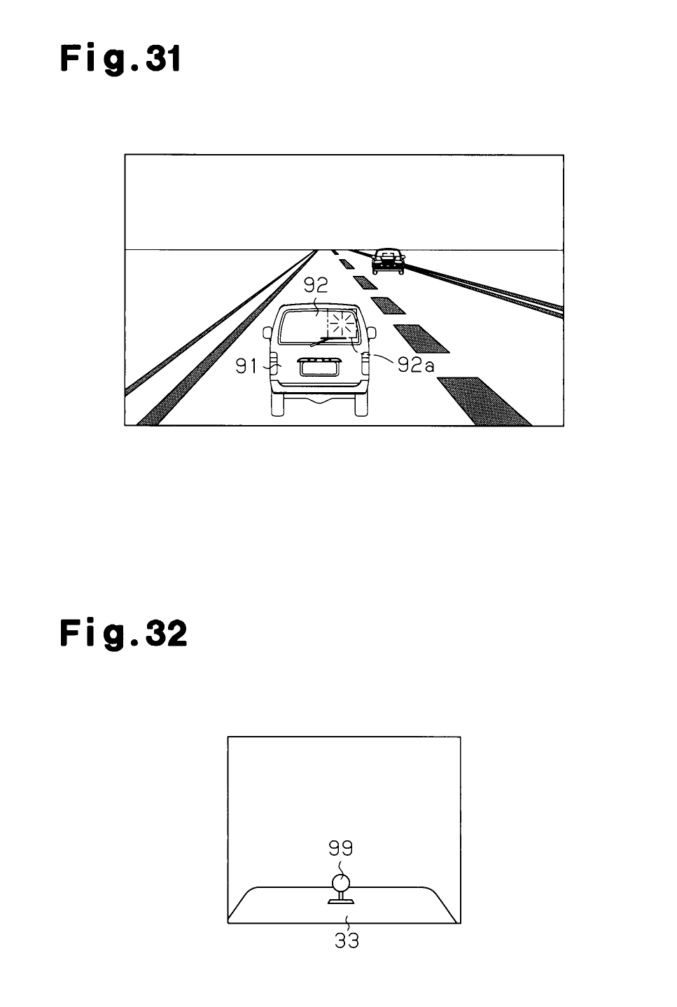

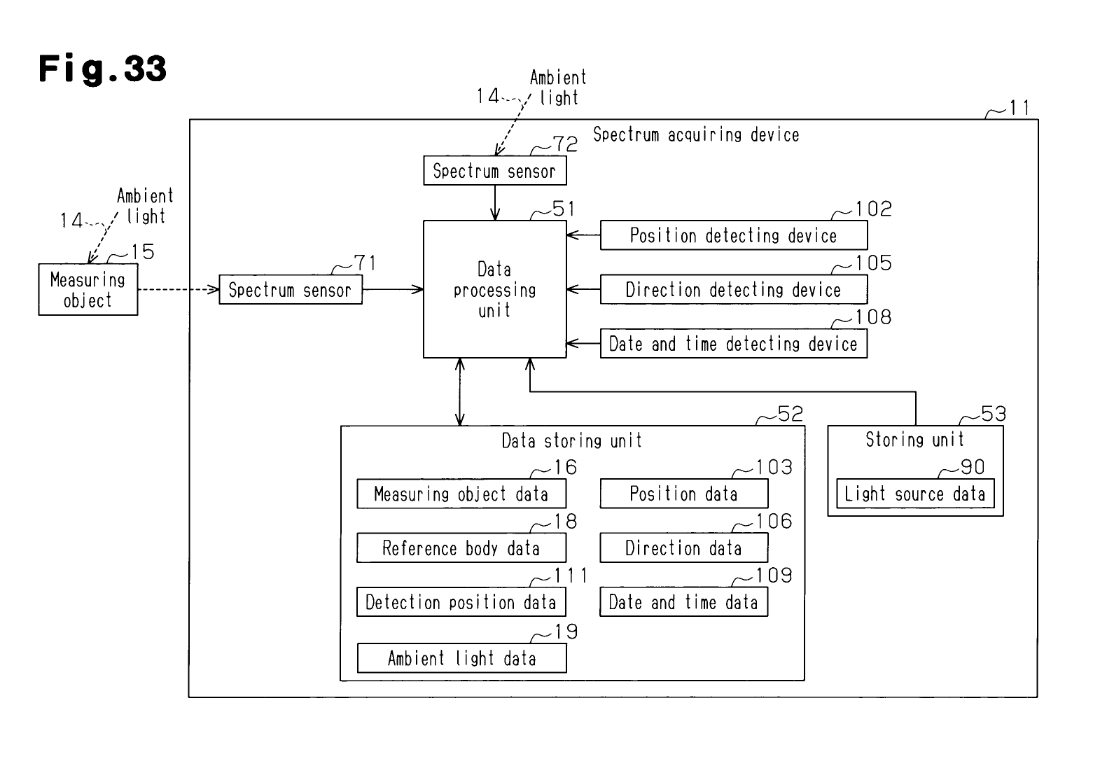

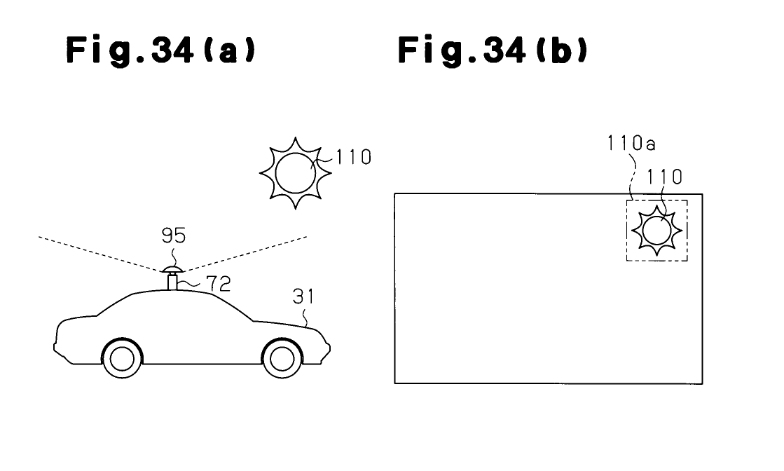

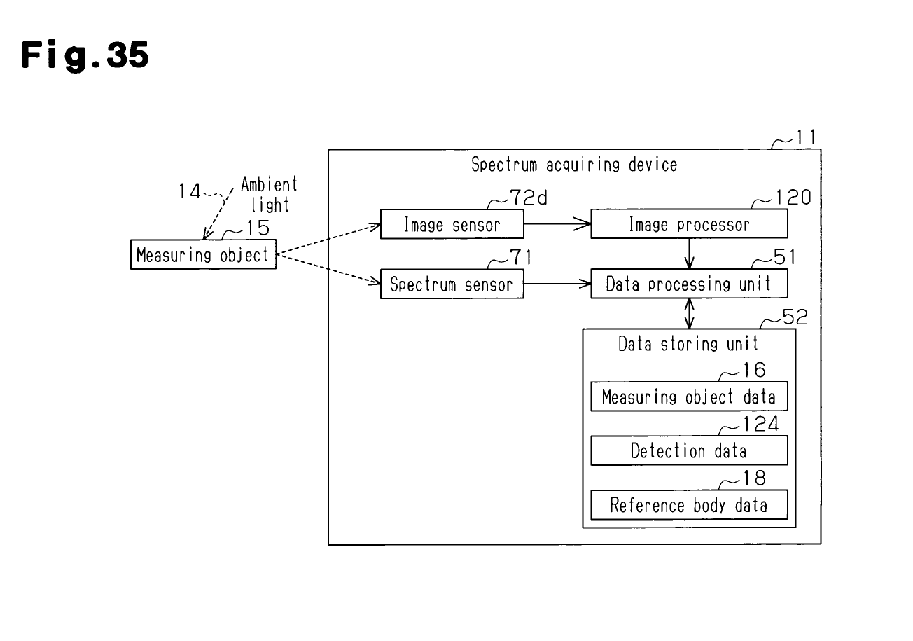

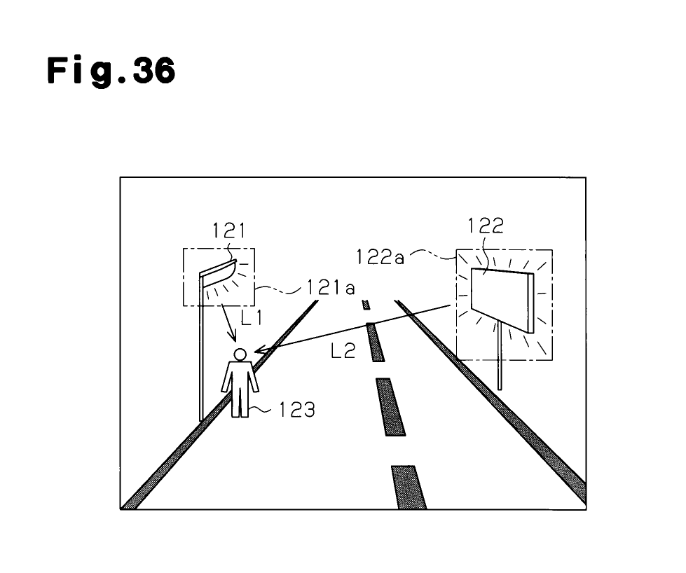

The data processing unit 21 of the spectrum converting device 12 stores the measuring object data 16 and the reference body data 18, which are input from the spectrum acquiring device 11, in a predetermined region of the data storing unit 22. The reference body reflectivity data 24 in the seventh embodiment is data indicating various traffic signs as the reference bodies 17 and the surface reflectivity of each traffic sign. FIG. 15(a) shows the traffic sign 61 indicating “No parking” and FIG. 15(b) is a graph showing reflectivity data regarding the traffic sign 61, representing wavelength as a horizontal axis and reflectivity as a vertical axis, and the reference body reflectivity data 24 is data obtained by associating the traffic sign with its surface reflectivity. FIG. 16(a) shows a traffic sign 62 indicating “No entry”, FIG. 17(a) is a traffic sign 63 indicating “Stop”, FIGS. 16(b) and 17(b) are graphs showing reflectivity data regarding these two traffic signs 62, 63, representing wavelength as a horizontal axis and reflectivity as a vertical axis, and the reference body reflectivity data 24 is data obtained by associating the traffic signs with respective surface reflectivities.

The data processing unit 21 of the spectrum converting device 12 reads the surface reflectivity corresponding to the traffic sign 61 set as the reference body 17 from the reference body reflectivity data 24 on the basis of the reference body data 18. The data processing unit 21 calculates the spectrum of the ambient light 14 on the basis of the read surface reflectivity and the spectrum of the reflected light from the reference body 17, which is stored in the reference body data 18. The data processing unit 21 stores data indicating the spectrum of the ambient light 14 as the ambient light data 19 in a predetermined region of the data storing unit 22. Then, the data processing unit 21 generates the measuring object reflectivity data 20 on the basis of the measuring object data 16 and the ambient light data 19, and outputs the generated data to the discrimination device 13.

As described above, the movable body spectrum measuring apparatus in the seventh embodiment can achieve following advantages in addition to the advantage (1) of the first embodiment.

(9) The specified object around the movable body can be set as the reference body 17.

(10) The traffic sign as the standardized object is selected as the specified object. Thus, even when the automobile 31 as the movable body moves, the surface reflectivity of the reference body 17 does not vary greatly. Furthermore, since the traffic sign often appears during movement of the automobile 31, the spectrum of the reflected light from the reference body 17 can be acquired with high frequency. Therefore, the frequency with which the spectrum of the ambient light 14 is calculated increases, the discrimination accuracy of the measuring object 15 is improved, accordingly.

The seventh embodiment may be modified as follows.

When a plurality of traffic signs are detected from the measuring object data 16, the spectrum of the ambient light 14 corresponding to each of the traffic signs may be calculated and the spectrum indicating an average value of the light intensity at each wavelength in the spectrums of the ambient light 14 or a mode value (mode) of the light intensity at each wavelength may be set as the spectrum of the ambient light. Even with such a configuration, the above-mentioned advantages can be achieved in addition to the advantage (1) of the first embodiment. In addition, since the spectrum of the ambient light 14 is found on the basis of the spectrums of the plurality of reference bodies 17, divergence between the actual spectrum of the ambient light 14 and the calculated spectrum of the ambient light 14 can be reduced.

The traffic sign as the specified object that can act as the reference body 17 only needs to be a traffic sign encountered during driving of the automobile 31 and for example, may be a “junction information board” indicating a junction of a road or an “attention-attracting signboard” calling driver's attraction, in addition to the above-mentioned traffic signs.

### Eighth Embodiment

Next, an eighth embodiment of the movable body spectrum measuring apparatus according to the present invention will be described with reference to FIG. 18. Since the eighth embodiment has the same basic configuration as the seventh embodiment, only differences will be described in detail below.

FIG. 18 shows a part of the detection range of the spectrum sensor 30 in the eighth embodiment. That is, in the eighth embodiment, as shown in FIG. 18, a road 64 used in movement of the automobile 31 as the movable body is selected as the specified object that can act as the reference body 17. Examples of the types of the road include a paved road and a gravel road, and physical properties of components constituting the surfaces of the road are generally known according to the types of the road. For this reason, the road can be set as the specified object that can act as the reference body 17. The reference body spectrum data 54 in the eighth embodiment is data obtained by associating the type of the road such as a paved road with the corresponding spectrum of the reflected light, which is obtained when the roads are irradiated with various ambient light with a known spectrum.

As represented by a line formed by a long dash alternating with two short dashes in FIG. 18, the data processing unit 51 extracts a detection position 64a, at which the spectrum that is substantially equal to the spectrum indicated by the reference body spectrum data 54 is detected, on the basis of the measuring object data 16 stored in the data storing unit 52 and the reference body spectrum data 54, and acquires the spectrum of the reflected light at the detection position 64a from the measuring object data 16. The data processing unit 51 reads the road 64 corresponding to the acquired spectrum from the reference body spectrum data 54, and sets the road 64 as the reference body 17. The data processing unit 51 generates the reference body data 18 as data obtained by associating the road 64 as the reference body 17 with the spectrum acquired from the detection position 64a of the measuring object data 16, and stores the generated data in a predetermined region of the data storing unit 52. The data processing unit 51 outputs the measuring object data 16 and the reference body data 18, which are stored in the data storing unit 52, to the spectrum converting device 12.

The data processing unit 21 of the spectrum converting device 12 stores the measuring object data 16 and the reference body data 18, which are input from the spectrum acquiring device 11, in a predetermined region of the data storing unit 22. The reference body reflectivity data 24 in the eighth embodiment is data indicating various roads as the reference bodies 17 and the surface reflectivity of each road. The data processing unit 21 reads the surface reflectivity of the roads 64 set as the reference body 17 from the reference body reflectivity data 24 on the basis of the reference body data 18. The data processing unit 21 calculates the spectrum of the ambient light 14 on the basis of the read surface reflectivity and the spectrum of the reflected light from the reference body 17, which is stored in the reference body data 18. The data processing unit 21 stores the spectrum of the ambient light 14 as the ambient light data 19 in a predetermined region of the data storing unit 22. Then, the data processing unit 21 generates the measuring object reflectivity data 20 on the basis of the measuring object data 16 and the ambient light data 19, and outputs the generated data to the discrimination device 13.

As described above, the eighth embodiment can also achieve the advantage (1) of the first embodiment and the advantages (9) and (10) of the seventh embodiment.

The eighth embodiment may be modified as follows.

Although the road 64 itself is selected as the object that can act as the reference body 17 in the eighth embodiment, the reference body 17 is not limited to this and may be a white line formed on the road 64. At this time, data regarding the white line is stored in the reference body spectrum data 54. With such a configuration, the advantage (1) of the first embodiment and the advantages (9) and (10) in the seventh embodiment can be achieved.

### Ninth Embodiment

Next, a ninth embodiment of the movable body spectrum measuring apparatus according to the present invention will be described with reference to FIG. 19. The ninth embodiment has the same basic configuration as the seventh embodiment, and thus only differences will be described in detail below. The configuration of the ninth embodiment is different from the configuration shown in FIG. 1 in that the spectrum of the ambient light 14 is acquired without using the surface reflectivity of the reference body 17.

FIG. 19 is a diagram showing a part of the detection range of the spectrum sensor 30 in the ninth embodiment. That is, in the ninth embodiment, the sky is selected as the specified object that can act as the reference body 17. The spectrum of the sky such as the spectrum in a sunny or cloudy weather on a certain date and time, is stored in the reference body spectrum data 54 in the ninth embodiment.

As represented by a line formed by a long dash alternating with two short dashes in FIG. 19, the data processing unit 51 extracts a detection position 65a, at which the spectrum that is substantially equal to the spectrum indicated by the reference body spectrum data 54, on the basis of the measuring object data 16 stored in the data storing unit 52 and the reference body spectrum data 54, and acquires the spectrum at the detection position 65a as the spectrum of a sky 65 from the measuring object data 16. The data processing unit 51 sets the acquired spectrum as the spectrum of the reference body 17, generates the reference body data 18 as data indicating the spectrum, and stores the generated data in a predetermined region of the data storing unit 52. Then, the data processing unit 51 outputs the measuring object data 16 and the reference body data 18 to the spectrum converting device 12.

In the ninth embodiment, the reference body reflectivity data 24 in the spectrum converting device 12 is data obtained by associating various spectrums of the sky with the corresponding spectrums of the ambient light 14. In other words, the data is data obtained by collecting the spectrum of the sky at a certain time and the spectrum of the ambient light 14 at this certain time at the same time and associating them with each other.

Then, the data processing unit 21 of the spectrum converting device 12 reads the spectrum of the ambient light 14 from the reference body reflectivity data 24 on the basis of the reference body data 18 and stores data indicating the read spectrum as ambient light data 29 in a predetermined region of the data storing unit. The data processing unit 21 generates the measuring object reflectivity data 20 from the generated ambient light data 19 and measuring object data 16, and outputs the generated data to the discrimination device 13.

As described above, the ninth embodiment can achieve the advantage (1) in the first embodiment and the advantages (9) and (10) in the seventh embodiment.

The ninth embodiment may be modified as follows.

When a plurality of spectrums for the sky are detected from the measuring object data 16, spectrums of the ambient light 14, which correspond to the spectrums for the sky, may be obtained and the spectrum indicating an average value of the light intensity at each wavelength or a mode value of the light intensity at each wavelength on the basis of the spectrums of the ambient light 14 may be set as the spectrum of the ambient light 14. Even with such a configuration, the advantage (1) in the first embodiment and the advantages (9) and (10) of the seventh embodiment can be achieved.

Further, in the ninth embodiment, the spectrum of the ambient light 14 is acquired on the basis of the spectrum of the sky 65. However, since the spectrum of the sky is sunlight scattering in the air, the spectrum of the sky 65 itself may be set as the spectrum of the ambient light 14.

The seventh to ninth embodiments may be modified as follows.

In the seventh to eleventh embodiment, although a part of the structural member of the automobile 31 as the movable body is not contained in the detection range of the spectrum sensor 30, the structural component of the automobile 31 may be contained in the detection range of the spectrum sensor 30.

### Tenth Embodiment

Next, a tenth embodiment of the movable body spectrum measuring apparatus according to the present invention will be described with reference to FIGS. 20 and 21. In the tenth embodiment, a part of the movable body is not contained in the detection range of the spectrum sensor and the specified object detected in the predetermined region in the detection range of the spectrum sensor is set as the reference body. Since configuration of the movable body spectrum measuring apparatus in the tenth embodiment is the same as the configuration shown in FIG. 1, only differences will be described below.

FIG. 20 is a block diagram showing electrical configuration of the spectrum acquiring device in the tenth embodiment and FIG. 21 is a diagram showing a part of the detection range of the spectrum sensor 30 in the tenth embodiment.

As shown in FIG. 20, the spectrum acquiring device 11 includes one spectrum sensor 30, the data processing unit 51, the data storing unit 52 and the storing unit 53.

The spectrum sensor 30 in the tenth embodiment, as shown in FIG. 21, is installed so as to set the front of the automobile 31 as the movable body as the detection range and so as not to detect a part of the automobile 31 in the detection range. The spectrum sensor 30 detects the spectrum of the reflected light from the measuring object 15 irradiated with the ambient light 14. The data processing unit 51 acquires data indicating the spectrum of the reflected light from the measuring object 15, which is detected by the spectrum sensor 30, as the measuring object data 16 and stores the acquired data in a predetermined region of the data storing unit 52.

Region data 55 is stored in the storing unit 53 constituting a region identifying unit. The region data 55 is data obtained by associating the specified object that can act as the reference body 17 with the region having high frequency of detecting the specified object in the detection range of the spectrum sensor 30. In the tenth embodiment, as shown in FIG. 21, even when the automobile 31 is moving, the road 64 including the detection position 64a that can be easily identified from the detection range of the spectrum sensor 30 is selected as the specified object. It is assumed that the type of the road 64 in the tenth embodiment is previously known.

The data processing unit 51 constituting the region identifying unit acquires the spectrum of the reflected light at the detection position 64a indicated by the region data 55 from the measuring object data 16 on the basis of the measuring object data 16 stored in the data storing unit 52 and the region data 55 stored in the storing unit 53, generates the reference body data 18 as data obtained by associating the type of the road 64 with the acquired spectrum, and stores the generated data in a predetermined region of the data storing unit 52. The data processing unit 51 outputs the measuring object data 16 and the reference body data 18, which are stored in the data storing unit 52, to the spectrum converting device 12 (FIG. 1).

As described above, the tenth embodiment can achieve following advantages in addition to the advantage (1) in the first embodiment.

(11) Since the detection position for detecting the reference body 17 around the movable body and the spectrum of the reflected light from the reference body 17 are previously decided, the spectrum of the reference body 17 can be easily acquired even when the reference body 17 is located around the movable body.

(12) By selecting the road 64 as the reference body 17, the detection position in the detection range of the spectrum sensor 30 can be easily predicted.

The tenth embodiment may be modified as follows.

Although a part of the automobile 31 as the movable body is not contained in the detection range of the spectrum sensor 30 in the tenth embodiment, a part of the automobile 31 may be contained in the detection range. Even with such a configuration, the above-mentioned advantages in addition to the advantage (1) of the first embodiment can be achieved.

### Eleventh Embodiment

Next, an eleventh embodiment of the movable body spectrum measuring apparatus according to the present invention will be described with reference to FIG. 22. The eleventh embodiment has the same basic configuration as the tenth embodiment shown in FIG. 1 except that the spectrum of the ambient light 14 is found without using the surface reflectivity of the reference body 17.

FIG. 22 is a diagram showing a part of the detection range of the spectrum sensor 30 in the eleventh embodiment. In the eleventh embodiment, the sky is selected as the specified object that can act as the reference body 17. That is, data regarding a detection position, at which the light spectrum of the sky is detected, is stored in the region data 55 stored in the storing unit 53 in the eleventh embodiment. FIG. 22 is a diagram showing an example of the detection position 65a at which the spectrum of the sky 65 is detected. As shown in the drawing, even when the sky is set as the specified object, the detection position in the detection range of the spectrum sensor 30 can be predicted relatively easily.

The data processing unit 51 constituting the region identifying unit acquires the light spectrum at the detection position 65a indicated by the region data 55 from the measuring object data 16 on the basis of the measuring object data 16 stored in the data storing unit 52 and the region data 55 stored in the storing unit 53. The data processing unit 51 generates the reference body data 18 as data indicating the acquired spectrum and stores the generated data in a predetermined region of the data storing unit 52. The data processing unit 51 outputs the measuring object data 16 data stored in the data storing unit 52 and the reference body data 18 to the spectrum converting device 12.

The data processing unit 21 of the spectrum converting device 12 stores the measuring object data 16 and the reference body data 18, which are input from the spectrum acquiring device 11, in a predetermined region of the data storing unit 22.

In the eleventh embodiment, as in the ninth embodiment, the reference body reflectivity data 24 stored in the storing unit 23 is data obtained by associating various spectrums of the sky with the corresponding spectrums of the ambient light 14. In other words, the data is obtained by collecting the spectrum of the sky at a certain time and the spectrum of the ambient light 14 at this certain time at the same time and associating them with each other.

Then, the data processing unit 21 of the spectrum converting device 12 reads the spectrum of the ambient light 14 from the reference body reflectivity data 24 on the basis of the reference body data 18 and stores data indicating the read spectrum as the ambient light data 29 in a predetermined region of the data storing unit. The data processing unit 21 generates the measuring object reflectivity data 20 from the generated ambient light data 19 and measuring object data 16, and outputs the generated data to the discrimination device 13 (FIG. 1).

As described above, the eleventh embodiment can achieve the advantage (1) in the first embodiment and the advantage (11) in the tenth embodiment.

The eleventh embodiment may be modified as follows.

Although a part of the automobile 31 as the movable body is not contained in the detection range of the spectrum sensor 30 in the eleventh embodiment as in the tenth embodiment, a part of the automobile 31 may be contained in the detection range. Even with such a configuration, the advantage (1) of the first embodiment and the advantage (11) of the tenth embodiment can be achieved.

### Twelfth Embodiment

Next, a twelfth embodiment of the movable body spectrum measuring apparatus according to the present invention will be described with reference to FIGS. 23 and 24. The twelfth embodiment has the same basic configuration as the first embodiment except that the spectrum of the measuring object 15 and the spectrum of the reference body 17 are acquired by different spectrum sensors, respectively. The differences will be described in detail below.

As shown in FIG. 23, in the movable body spectrum measuring apparatus in the twelfth embodiment, the spectrum acquiring device 11 includes two spectrum sensors 71, 72. Among these spectrum sensors 71, 72, one spectrum sensor 71 acquires the spectrum of the reflected light from the measuring object 15 and the other spectrum sensor 72 acquires the spectrum of the reflected light from the reference body 17. The spectrum sensors 71, 72 detect the spectrums in respective detection ranges at the same time.

The spectrum sensor 71 is installed at the rear view mirror 32 of the automobile 31 as the movable body and sets the front of the automobile 31 as the detection range. The spectrum sensor 72, as shown in FIG. 24(a), is installed at a rear part of the automobile 31 and sets the rear of the automobile 31 as the detection range (for the sake of convenience, the spectrum sensor setting the rear of the automobile 31 as the detection range is referred to as a rear view camera 72a).

FIG. 24(b) is a diagram showing the detection range of the rear view camera 72a. As shown in the drawing, the rear view camera 72a is installed such that a rear bumper 74 constituting the automobile 31 is contained in the detection range. That is, when the spectrum of the reflected light in the detection range is detected by use of the rear view camera 72a, the spectrum of the reflected light from the rear bumper 74 irradiated with the ambient light 14 is detected at all times. In the twelfth embodiment, as represented by a line formed by a long dash alternating with two short dashes in FIG. 24(b), a part of the rear bumper 74 is set as a detection position 74a for detecting the spectrum of the reference body 17. That is, in the twelfth embodiment, the rear bumper 74 is set as the reference body 17. Thereby, even if the automobile 31 moves, the same reference body 17 is arranged in the detection range of the rear view camera 72a at all times. Even if the ambient light 14 varies, the spectrum is detected from the same reference body 17 at all times.

The spectrum acquiring device 11 outputs the measuring object data 16 as data indicating the spectrum of the reflected light at each position in the detection range of the spectrum sensor 71 to the spectrum converting device 12. The spectrum acquiring device 11 acquires the spectrum corresponding to the detection position 74a of the reference body 17 from the spectrum of the reflected light at the position in the detection range of the rear view camera 72a, and outputs data indicating the spectrum as the reference body data 18 to the spectrum converting device 12.

In the twelfth embodiment, data regarding the surface reflectivity of the rear bumper 74 as the reference body reflectivity data 24, that is, data regarding the surface reflectivity of paint applied to the rear bumper 74 is stored in the storing unit 23 of the spectrum converting device 12. Then, the spectrum converting device 12 calculates the spectrum of the ambient light 14 on the basis of the reference body data 18 and the reference body reflectivity data 24.

As described above, the twelfth embodiment can achieve following advantages.

(13) The spectrum of the reflected light from the measuring object 15 and the spectrum of the reflected light from the reference body 17 are detected by the different spectrum sensors 71, 72. Thus, as compared to the case where both spectrums from the measuring object 15 and the reference body 17 are acquired by one spectrum sensor, the flexibility for setting of the reference body 17 is increased.

(14) The rear view camera 72a for detecting the spectrum of the reflected light from the reference body 17 is installed such that the rear bumper 74 constituting the automobile 31 is contained in the detection range. Thereby, a part of the rear bumper 74 constituting the automobile 31 can be selected as the reference body 17 that acts as a reference at the time when the measuring object data 16 is corrected (converted) at all times. As a result, in both cases where the automobile 31 moves and where the ambient light 14 varies, the spectrum of the ambient light 14 can be calculated on the basis of the same spectrum of the reflected light from the reference body 17 at all times.

(15) Therefore, the spectrum of the ambient light 14 is calculated as appropriate and the measuring object 15 is discriminated on the basis of the spectrum of the ambient light 14. As a result, the discrimination accuracy of the measuring object can be improved.

The twelfth embodiment may be modified as follows.

In the twelfth embodiment, the rear bumper 74 contained in the detection range of the rear view camera 72a is set as the reference body 17. The reference body 17 is not limited to this and, as shown in FIG. 24(b), may be a part of the movable body contained in the detection range of the rear view camera 72a, such as a license plate 75. In this case, data regarding the surface reflectivity of the license plate 75 is stored in the reference body reflectivity data 24 of the spectrum converting device 12.

Alternatively, for example, the reflective member 36 may be attached to the rear bumper 74 and the reflective member 36 may be set as the reference body 17. In this case, data regarding the surface reflectivity of the reflective member 36 is stored in the reference body reflectivity data 24 of the spectrum converting device 12.

Even with such a configuration, the advantages (13) to (15) of the twelfth embodiment can be achieved.

### Thirteenth Embodiment

Next, a thirteenth embodiment of the movable body spectrum measuring apparatus according to the present invention will be described with reference to FIG. 25. Since the thirteenth embodiment has the same basic configuration as the twelfth embodiment, only differences will be described in detail below.

FIG. 25(a) is a diagram showing the installation position of the spectrum sensor 72 in the thirteenth embodiment and FIG. 25(b) is a diagram showing a part of the detection range of the spectrum sensor 72.

First, as shown in FIG. 25(a), the spectrum sensor 72 in the thirteenth embodiment is a side camera 72b installed at a side mirror 76 of the automobile 31 as the movable body. The side camera 72b sets a part of the automobile 31 in the rear of the side mirror 76 provided at a side part of the automobile 31 as the detection range. The side camera 72b, as shown in FIG. 25(b), is installed such that a door 77 constituting the automobile 31 is contained in the detection range. In the thirteenth embodiment, as represented by a line formed by a long dash alternating with two short dashes in FIG. 25(b), a detection position corresponding to a part of the door 77 is set as a detection position 77a for detecting the spectrum of the reference body 17. That is, in the thirteenth embodiment, the door 77 is set as the reference body 17.

The spectrum acquiring device 11 outputs the measuring object data 16 as data indicating the spectrum of the reflected light at each position in the detection range of the spectrum sensor 71 to the spectrum converting device 12. The spectrum acquiring device 11 also acquires the spectrum corresponding to the detection position 77a of the reference body 17 from the spectrum of the reflected light at each position in the detection range of the side camera 72b and outputs the data indicating the spectrum as the reference body data 18 to the spectrum converting device 12.

In the thirteenth embodiment, data regarding the surface reflectivity of the door 77 as the reference body reflectivity data 24, that is, data regarding the surface reflectivity of paint applied to the door 77 is stored in the storing unit 23 of the spectrum converting device 12. Then, the spectrum converting device 12 calculates the spectrum of the ambient light 14 on the basis of the reference body data 18 and the reference body reflectivity data 24.

As described above, the thirteenth embodiment can achieve the advantages (13) to (15) in the twelfth embodiment.

The thirteenth embodiment may be modified as follows.

In the thirteenth embodiment, the door 77 contained in the detection range of the side camera 72b is set as the reference body 17. The reference body 17 is not limited to this and may be another member as long as it is a part of the movable body that is contained in the detection range of the side camera 72b. Alternatively, the reflective member 36 may be attached to the door 77, for example, and the reflective member 36 may be set as the reference body 17. In this case, data regarding the surface reflectivity of the reflective member 36 is stored in the reference body reflectivity data 24 of the spectrum converting device 12. Even with such a configuration, the advantages (13) to (15) of the twelfth embodiment, that is the same advantages as those of a fourteenth embodiment can be achieved as discussed below.

### Fourteenth Embodiment

Next, the fourteenth embodiment of the movable body spectrum measuring apparatus according to the present invention will be described with reference to FIG. 26. Since the fourteenth embodiment has the same basic configuration as the twelfth embodiment shown in FIG. 23, only differences will be described in detail below.

FIG. 26 is a diagram showing the installation position of the spectrum sensor 72 in the fourteenth embodiment. As shown in FIG. 26, the spectrum sensor 72 in the fourteenth embodiment is an interior camera 72c that is installed on the instrument panel 45 constituting the automobile 31 as the movable body and sets the inside of the automobile 31 as the detection range. A part of the instrument panel 45, a part of a driver's seat and a part of a ceiling is contained in the detection range of the interior camera 72c. The above-mentioned reflective member 36 as the reference body 17 is arranged on the instrument panel 45 located in the detection range of the interior camera 72c. Since the ambient light 14, also as shown in FIG. 26, is incident from the outside onto the inside of the automobile 31, the ambient light 14 reflected from the reflective member 36 is incident on the interior camera 72c.

The spectrum acquiring device 11 acquires the spectrum at the detection position corresponding to the reflective member 36 from the spectrum of the reflected light at each position in the detection range of the interior camera 72c and outputs data indicating the spectrum as the reference body data 18 to the spectrum converting device 12.

With such a configuration, the advantages (12) to (15) in the twelfth embodiment and the advantage (6) in the second embodiment can be achieved.

The fourteenth embodiment may be modified as follows.

In the thirteenth embodiment, the reflective member 36 provided at the instrument panel 45 is set as the reference body 17. The reference body 17 is not limited to this, and may be any member as long as it is located in the detection range of the spectrum sensor 72 and exists inside of the automobile 31, and as shown in FIG. 26, may be a reflective member 78 attached to the ceiling in the automobile. Alternatively, the reference body 17 may be a part of a seat 79 or the instrument panel 45 itself. Even with such a configuration, the advantages (12) to (15) of the twelfth embodiment and the advantage (6) of the second embodiment can be achieved.

The twelfth to fourteenth embodiments may be modified as follows.

In the twelfth to fourteenth embodiments, although the rear view camera 72a, the side camera 72b and the interior camera 72c are used as the second spectrum sensor having the detection range containing the structural member of the automobile 31 as the movable body, the second spectrum sensor is not limited to this and may be any member as long as it is mounted on the automobile 31 and has a detection range containing the structural member of the automobile 31 irradiated with the ambient light 14.

### Fifteenth Embodiment

Next, a fifteenth embodiment of the movable body spectrum measuring apparatus according to the present invention will be described with reference to FIGS. 27 and 14. The fifteenth embodiment has the same basic configuration as the seventh embodiment shown in FIG. 7 except that spectrum of the measuring object 15 and the spectrum of the reference body 17 are acquired by the different spectrum sensors, respectively, and only the differences will be described in detail below.

As shown in FIG. 27, the spectrum acquiring device 11 in the fifteenth embodiment has the spectrum sensor 71 for acquiring the spectrum of the reflected light from the measuring object 15 irradiated with the ambient light 14 and the spectrum sensor 72 for acquiring the spectrum of the reflected light from the reference body 17 irradiated with the ambient light 14. The spectrum sensor 71 sets the front of the automobile 31 as the detection range.

The data processing unit 51 of the spectrum acquiring device 11 captures the light spectrum detected by the spectrum sensor 71 at each position in the detection range as the measuring object data 16 and stores the data in a predetermined region of the data storing unit 52. The data processing unit 51 also captures the light spectrum detected by the spectrum sensor 72 at each position in the detection range and stores the data as provisional reference body data 80 in a predetermined region of the data storing unit 52.

The reference body spectrum data 54 is stored in the storing unit 53 of the spectrum acquiring device 11. The reference body spectrum data 54 is data obtained by associating the specified object that can act as the reference body 17 with the spectrum of the reflected light at the time when the specified object is irradiated with various ambient light having known spectrums. In the fifteenth embodiment, the traffic sign shown in FIG. 14 is selected as the specified object that can act as the reference body 17. In other words, the reference body spectrum data 54 in the fifteenth embodiment, as in the seventh embodiment, is data obtained by associating the spectrum of the reflected light from the traffic sign at the time when the traffic sign is irradiated with various ambient light with the traffic sign.

As represented by a line formed by a long dash alternating with two short dashes in FIG. 14, the data processing unit 51 extracts the detection position 61a, at which the spectrum that is substantially equal to the spectrum indicated by the reference body spectrum data 54 is detected, on the basis of the provisional reference body data 80 stored in the data storing unit 52 and the reference body spectrum data 54, and acquires the spectrum of the reflected light at the detection position 61a from the provisional reference body data 80. The data processing unit 51 reads the traffic sign 61 as the traffic sign corresponding to the acquired spectrum from the reference body spectrum data 54 and sets the traffic sign 61 as the reference body 17. The data processing unit 51 generates the reference body data 18 as data obtained by associating the traffic sign 61 as the reference body 17 with the spectrum acquired from the provisional reference body data 80, and stores the generated data in a predetermined region of the data storing unit 52. The data processing unit 51 outputs the measuring object data 16 and the reference body data 18, which are stored in the data storing unit 52, to the spectrum converting device 12 (FIG. 1).

As described above, the fifteenth embodiment can achieve the advantages (9) and (10) in the seventh embodiment and the advantage (13) in the twelfth embodiment.

The fifteenth embodiment may be modified as follows.

When a plurality of traffic signs are detected from the provisional reference body data 80, the spectrums of the ambient light 14, which correspond to the traffic signs, may be calculated, and on basis of these spectrums of the ambient light 14, the light spectrum indicating an average value of the light intensity at each wavelength or a mode value of the light intensity at each wavelength may be set as the ambient light spectrum. Even with such a configuration, the advantages (9) and (10) in the seventh embodiment and the advantage (13) in the twelfth embodiment can be achieved. In addition, by obtaining the spectrum of the ambient light 14 on the basis of the plurality of spectrums of the reference body 17, divergence between the actual spectrum of the ambient light 14 and the calculated spectrum of the ambient light 14 can be reduced.

### Sixteenth Embodiment

Next, a sixteenth embodiment of the movable body spectrum measuring apparatus according to the present invention will be described with reference to FIGS. 27 and 24. The sixteenth embodiment has the same basic configuration as the eighth embodiment except that the spectrum of the measuring object 15 and the spectrum of the reference body 17 are acquired by the different spectrum sensors, respectively.

In the sixteenth embodiment, as in the eighth embodiment, a road 81 used in movement of the automobile 31 as the movable body is selected as the specified object that can act as the reference body 17 as shown in FIG. 24. The reference body spectrum data 54 in the sixteenth embodiment is data obtained by associating the type of the road 81 with the spectrum of the reflected light obtained at the time when the various roads are irradiated with various ambient light having known spectrums.

In the sixteenth embodiment, since the road is selected as the specified object that can act as the reference body 17, it is preferable to use the rear view camera 72a described in the twelfth embodiment as the spectrum sensor 72. The reason is that the rear view camera 72a, as shown in FIG. 24(a), sets a region in the rear of the automobile 31, which becomes a dead area when the driver of the automobile 31 checks the rear of the automobile 31 by use of the rear view mirror 32, as a main detection range. In other words, the rear view camera 72a sets the vicinity of the automobile 31 in the rear of the automobile 31 as the detection range. For this reason, a proportion of the road in the detection range of the rear view camera 72a naturally increases.

As shown in FIG. 24(b), the data processing unit 51 extracts a detection position 81a, at which the spectrum that is substantially equal to the spectrum indicated by the reference body spectrum data 54 is detected, on the basis of the provisional reference body data 80 stored in the data storing unit 52 and the reference body spectrum data 54, and acquires the spectrum of the reflected light at the detection position 81a from the provisional reference body data 80. The data processing unit 51 reads the road 81 corresponding to the acquired spectrum from the reference body spectrum data 54 and sets the road 81 as the reference body 17. The data processing unit 51 generates the reference body data 18 as data obtained by associating the road 81 as the reference body 17 with the spectrum acquired at the detection position 81a of the provisional reference body data 80, and stores the generated data in a predetermined region of the data storing unit 52. The data processing unit 51 outputs the measuring object data 16 and the reference body data 18, which are stored in the data storing unit 52, to the spectrum converting device 12.

As described above, the sixteenth embodiment can achieve the advantages (9) and (10) in the seventh embodiment and the advantage (13) in the twelfth embodiment.

### Seventeenth Embodiment

Next, a seventeenth embodiment of the movable body spectrum measuring apparatus according to the present invention will be described with reference to FIGS. 27 and 19. The seventeenth embodiment has the same basic configuration as the ninth embodiment except that the spectrum of the measuring object 15 and the spectrum of the reference body 17 are acquired by the different spectrum sensors, respectively.

As shown in FIG. 27, the data processing unit 51 captures the light spectrum detected at each position in the detection range by the spectrum sensor 71 as the measuring object data 16 and stores the data in a predetermined region of the data storing unit 52. The data processing unit 51 also captures the light spectrum detected at each position in the detection range by the spectrum sensor 72 as the provisional reference body data 80 and stores the data in a predetermined region of the data storing unit 52.

In the seventeenth embodiment, as in the ninth embodiment, the sky is selected as the specified object that can act as the reference body 17 as shown in FIG. 19. Spectrums of the sky are stored in the reference body spectrum data 54 in the seventeenth embodiment. For example, the spectrum in the sunny weather at a certain date and time and the spectrum in the cloudy weather are stored.

As represented by a line formed by a long dash alternating with two short dashes in FIG. 19, the data processing unit 51 extracts the detection position 65a, at which the spectrum that is substantially equal to the spectrum indicated by the reference body spectrum data 54 is detected, on the basis of the provisional reference body data 80 stored in the data storing unit 52 and the reference body spectrum data 54, and acquires the spectrum at the detection position 65a as the spectrum of the sky 65 from the provisional reference body data 80. The data processing unit 51 sets the acquired spectrum as the spectrum of the reference body 17, generates the reference body data 18 as data indicating the spectrum, and stores the data in a predetermined region of the data storing unit 52. Then, the data processing unit 51 outputs the measuring object data 16 and the reference body data 18 to the spectrum converting device 12 (FIG. 1).

The reference body reflectivity data 24 in the spectrum converting device 12 in the seventeenth embodiment, as in the ninth embodiment, is data obtained by associating various spectrums of the sky with the corresponding spectrums of the ambient light 14.

Then, the data processing unit 21 of the spectrum converting device 12 (FIG. 1) reads the spectrum of the ambient light 14 from the reference body reflectivity data 24 on the basis of the reference body data 18 and stores the read data indicating the spectrum as the ambient light data 19 in a predetermined region of the data storing unit. The data processing unit 21 generates the measuring object reflectivity data 20 from the generated ambient light data 19 and measuring object data 16 and outputs the generated data to the discrimination device 13 (FIG. 1).

As described above, the sixteenth embodiment can achieve the advantages (9) and (10) in the seventh embodiment and the advantage (13) in the twelfth embodiment.

The seventeenth embodiment may be modified as follows.

When the spectrums of a plurality of skies are detected from the provisional reference body data 80, the spectrums of the ambient light 14 corresponding to the spectrums may be found and the spectrum indicating an average value of the light intensity at each wavelength or a mode value of the light intensity at each wavelength may be used as the ambient light spectrum on the basis of these spectrums of the ambient light 14. Even with such a configuration, the advantages (9) and (10) of the seventh embodiment and the advantage (13) of the twelfth embodiment can be achieved. In addition, since the spectrum of the ambient light 14 is obtained based on the plurality of spectrums of the reference body 17, divergence between the actual spectrum of the ambient light 14 and the calculated spectrum of the ambient light 14 can be reduced.

In the seventeenth embodiment, the spectrum of the ambient light 14 is acquired on the basis of the spectrum of the sky 65. However, since the spectrum of the sky is sunlight scattering in the air, the spectrum of the sky 65 itself may be set as the spectrum of the ambient light 14.

In the fifteenth to seventeenth embodiments, the spectrum sensor 72 for acquiring the spectrum of the reference body 17 is not specifically limited and only needs to be mounted on the automobile 31.

### Eighteenth Embodiment

Next, an eighteenth embodiment of the movable body spectrum measuring apparatus according to the present invention will be described with reference to FIGS. 28 and 24. The eighteenth embodiment has the same basic configuration as the tenth embodiment except that the spectrum of the measuring object 15 and the spectrum of the reference body 17 are acquired by the different spectrum sensors, respectively.

As shown in FIG. 28, the spectrum acquiring device 11 includes the spectrum sensor 71 for detecting the spectrum of the reflected light from the measuring object 15 irradiated with the ambient light 14 and the spectrum sensor 72 for detecting the spectrum of the reflected light from the reference body 17 irradiated with the ambient light 14. The spectrum sensor 71 sets the front of the automobile 31 as the movable body as the detection range.

The data processing unit 51 captures the light spectrums detected at each position in the detection range by the spectrum sensor 71 as the measuring object data 16 and stores the data in a predetermined region of the data storing unit 52. The data processing unit 51 also captures the light spectrum detected at each position in the detection range by the spectrum sensor 72 as the provisional reference body data 80 and stores the data in a predetermined region of the data storing unit 52.

The region data 55 is stored in the storing unit 53 constituting the region identifying unit. The region data 55, as described above, is data obtained by associating the specified object that can act as the reference body 17 in the detection range of the spectrum sensor 72 with the region where the detection frequency of the specified object is high. In the eighteenth embodiment, the road shown in FIG. 24(b) is selected as the specified object and the rear view camera 72a is used as the spectrum sensor 72. As described above, by using the rear view camera 72a as the spectrum sensor 72, the detection position 81a, at which the spectrum of the reflected light from the road 81 is detected, can be discriminated easily. It is assumed that the type of the road 81 in the eighteenth embodiment is known.

The data processing unit 51 constituting the region identifying unit acquires the spectrum of the reflected light at the detection position 81a indicated by the region data 55 from the provisional reference body data 80 on the basis of the provisional reference body data 80 stored in the data storing unit 52 and the region data 55 stored in the storing unit 53. The data processing unit 51 generates the reference body data 18 as data obtained by associating the type of the road 81 with the acquired spectrum, and stores the data in a predetermined region of the data storing unit 52. The data processing unit 51 outputs the measuring object data 16 and the reference body data 18, which are stored in the data storing unit 52, to the spectrum converting device 12 (FIG. 1).

As described above, the eighteenth embodiment can achieve the advantages (11) and (12) in the tenth embodiment and the advantage (13) in the twelfth embodiment.

The eighteenth embodiment may be modified as follows.

In the eighteenth embodiment, the rear view camera 72a is used as the spectrum sensor 72 for acquiring the spectrum of the reflected light from the reference body 17. The spectrum sensor 72 is not limited to this, and may be the side camera 72b, for example, as long as it is mounted on the automobile and the road is contained in the detection range. Even with such a configuration, the advantages (11) and (12) of the tenth embodiment and the advantage (13) of the twelfth embodiment can be achieved.

### Nineteenth Embodiment

Next, a nineteenth embodiment of the movable body spectrum measuring apparatus according to the present invention will be described with reference to FIGS. 28 and 22. The nineteenth embodiment has the same basic configuration as the eleventh embodiment except that the spectrum of the measuring object 15 and the spectrum of the reference body 17 are acquired by different spectrum sensors, respectively. The differences will be described below.

In the nineteenth embodiment, as in the eleventh embodiment, the sky is selected as the specified object that can act as the reference body 17. That is, data regarding a detection position, at which the light spectrum of the sky is detected, in the detection range of the spectrum sensor 72 as the front of the movable body, is stored in the region data 55 stored in the storing unit 53 in the nineteenth embodiment. Also as shown in FIG. 22, even when the sky 65 is used as the specified object, the detection position 65a in the detection range of the spectrum sensor 72 can be predicted relatively easily.

The data processing unit 51 acquires the light spectrum at the detection position 65a indicated by the region data 55 from the provisional reference body data 80 on the basis of the provisional reference body data 80 stored in the data storing unit 52 and the region data 55 stored in the storing unit 53. The data processing unit 51 generates the reference body data 18 as data indicating the acquired spectrum, and stores the data in a predetermined region of the data storing unit 52. The data processing unit 51 outputs the measuring object data 16 and the reference body data 18, which are stored in the data storing unit 52, to the spectrum converting device 12 (FIG. 1).

As described above, the nineteenth embodiment also can achieve the advantages (11) and (12) in the tenth embodiment and the advantage (13) in the twelfth embodiment.

The nineteenth embodiment may be modified as follows.

In the nineteenth embodiment, although the front of the automobile 31 is set as the detection range of the spectrum sensor 72, in detecting the spectrum of the sky, the detection range of the spectrum sensor 72 may be, for example, a region immediately above the automobile 31.

### Twentieth Embodiment

Next, a twentieth embodiment of the movable body spectrum measuring apparatus according to the present invention will be described with reference to FIGS. 29 and 14.

As shown in FIG. 29, the spectrum acquiring device 11 in the twentieth embodiment has the spectrum sensor 71 for detecting the spectrum and an image sensor 72d capable of acquiring a visible image, and is installed such that both the sensors have the same detection range.

Here, the spectrum sensor 71 detects the spectrum of the reflected light from the measuring object 15 irradiated with the ambient light 14, and the data processing unit 51 captures the spectrum detected at each position in the detection range by the spectrum sensor 71 as the measuring object data 16 and stores the data in a predetermined region of the data storing unit 52.

The image sensor 72d is a sensor for generating and outputting visible image data in the detection range, and an image processor 85 of the spectrum acquiring device 11 captures the generated and output visible image data. On the basis of an image processing result of the visible image data, the image processor 85 discriminates an object located in the detection range, detects the specified object that can act as the reference body 17 and detects a detection position of the specified object in the detection range of the spectrum sensor 71. In the twentieth embodiment, the same detection range of the two types of sensors is set as the range shown in FIG. 14, the traffic sign 61 is detected as the specified object and the detection position 61a is detected as the detection position. At this time, the image processor 85 generates detection position data 86 as data obtained by associating the traffic sign 61 shown in FIG. 14 with the detection position 61a. The data processing unit 51 captures the detection position data 86 generated by the image processor 85 and stores the data in a predetermined region of the data storing unit 52. Then, the data processing unit 51 acquires the spectrum of the reflected light at the detection position 61a of the specified object from the measuring object data 16 on the basis of the detection position data 86 and the measuring object data 16. The data processing unit 51 generates the reference body data 18 as data obtained by associating the traffic sign 61 as the reference body 17 with the acquired spectrum, stores the data in a predetermined region of the data storing unit 52 and outputs the measuring object data 16 and the reference body data 18 to the spectrum converting device 12 (FIG. 1).

The data processing unit 21 of the spectrum converting device 12 stores the measuring object data 16 and the reference body data 18, which are thus input from the spectrum acquiring device 11, in a predetermined region of the data storing unit 22. Data obtained by associating the various specified objects that can become the reference body 17 with the surface reflectivity of the specified objects is stored in the reference body reflectivity data 24 in the storing unit 23. The data processing unit 21 reads the surface reflectivity corresponding to the traffic sign 61 from the reference body reflectivity data 24 on the basis of the reference body data 18 and the reference body reflectivity data 24. The data processing unit 21 generates the ambient light data 19 indicating the spectrum of the ambient light 14 on the basis of the read surface reflectivity and the spectrum of the traffic sign 61, and stores the data in a predetermined region of the data storing unit 22. Then, the data processing unit 21 generates the measuring object reflectivity data 20 of the measuring object 15 on the basis of the generated ambient light data 19 and measuring object data 16, and outputs the data to the discrimination device 13 (FIG. 1).

As described above, the twentieth embodiment can also achieve the advantage (13) of the twelfth embodiment.

### Twenty-First Embodiment

Next, a twenty-first embodiment of the movable body spectrum measuring apparatus according to the present invention will be described with reference to FIGS. 30 to 32. In the twenty-first embodiment, an object that produces specular reflection of sunlight from the sun as a light source for the ambient light 14 is used as the reference body 17.

As shown in FIG. 30, the spectrum acquiring device 11 in the twenty-first embodiment has one spectrum sensor 30. The spectrum sensor 30, as shown in FIG. 31, sets the front of the automobile 31 as the movable body as the detection range and detects the spectrum of the reflected light from the measuring object 15 irradiated with the ambient light 14.

The data processing unit 51 of the spectrum acquiring device 11 captures the light spectrum detected at each position in the detection range by the spectrum sensor 30 as the measuring object data 16 and stores the data in a predetermined region of the data storing unit 52.

In the automobile 31, according to surrounding environment, sunlight of the sun as a light source for the ambient light 14 may be reflected specularly from a rear glass of an automobile running ahead, a windshield of an automobile coming from the opposite direction, a window pane of a surrounding building or the like, and the automobile may be irradiated with the specularly reflected light. In the twenty-first embodiment, as shown in FIG. 31, the automobile 31 is irradiated with the above-mentioned specularly reflected light from a rear glass 92 of an automobile 91 traveling forward. In the twenty-first embodiment, a part emitting the reflected light (a detection position 92a of the rear glass 92) is set as the reference body 17.

The light intensity of such specularly reflected light of sunlight at each wavelength is larger than that of reflected light from the road, for example, since it is specularly reflected light of sunlight. Thus, light source data 90 for determining whether the light spectrum detected by the spectrum sensor 30 is the spectrum of sunlight or the spectrum of specularly reflected sunlight, which is similar to sunlight, is stored in the storing unit 53 of the spectrum acquiring device 11 in the twenty-first embodiment. The light source data 90 is data obtained by associating the detected spectrum with a reference value of the light intensity for each wavelength in order to determine whether the detected spectrum is the spectrum of sunlight or the spectrum of light similar to sunlight. By providing the light source data 90, it is possible to determine whether the spectrum detected by the spectrum sensor 30 is the spectrum of sunlight or the spectrum of light similar to sunlight.

The data processing unit 51 extracts the light spectrum that satisfies the reference value of the light source data 90 from the measuring object data 16 on the basis of the measuring object data 16 and the light source data 90. The data processing unit 51 captures the spectrum that satisfies the reference value as the spectrum of the reflected light from the reference body 17, and in the twenty-first embodiment, stores the data as the ambient light data 19 in a predetermined region of the data storing unit 52. Then, the data processing unit 51 outputs the measuring object data 16 and the ambient light data 19 to the spectrum converting device 12 (FIG. 1).

Thereby, it is possible to directly acquire the spectrum of the sun as the light source for the ambient light 14, that is, the spectrum of the ambient light 14. When a plurality of spectrums that satisfy the light source data 90 are detected from the measuring object data 16, the spectrum indicating an average value for the light intensity at each wavelength or a mode value for the light intensity at each wavelength of these spectrums may be calculated and the spectrum may be set as the spectrum for the ambient light 14.

The data processing unit 21 of the spectrum converting device 12 stores the measuring object data 16 and the ambient light data 19, which are input from the spectrum acquiring device 11, in a predetermined region of the data storing unit 22. Then, the data processing unit 21 generates the measuring object reflectivity data 20 on the basis of the measuring object data 16 and the ambient light data 19 and outputs the generated data to the discrimination device 13 (FIG. 1).

As described above, the twenty-first embodiment can achieve following advantages.

(16) By providing the light source data 90 for determining whether the light spectrum detected by the spectrum sensor 30 is the spectrum of sunlight or the spectrum of light similar to sunlight, the spectrum of sunlight or the spectrum of light similar to sunlight can be acquired from the spectrum detected by the spectrum sensor 30. In other words, the spectrum of the ambient light 14 can be directly acquired.

The twenty-first embodiment may be modified as follows. FIG. 32 is a diagram showing a part of the detection range of the spectrum sensor 30 in a modified example of the twenty-first embodiment.

The twenty-first embodiment describes the aspect in which specularly reflected sunlight is applied from the object other than the automobile 31. Alternatively, a member on which sunlight is specularly reflected may be provided at the automobile 31 itself. For example, as shown in FIG. 32, this can be implemented by providing a mirror-finished sphere 99 on the hood 33. Thereby, the frequency of detecting specularly reflected sunlight in the detection range of the spectrum sensor 30 can be increased. The installation position of such mirror-finished sphere 99 may be any position as long as it falls within the detection range of the spectrum sensor 30. It is preferred that each reference value of the light source data 90 is appropriately changed according to the date and time, place or the like.

### Twenty-Second Embodiment

Next, a twenty-second embodiment of the movable body spectrum measuring apparatus according to the present invention will be described with reference to FIGS. 33 and 34. In the twenty-second embodiment, the sun as the light source for the ambient light 14 is selected as the reference body 17.

As shown in FIG. 33, the spectrum acquiring device 11 in the twenty-second embodiment has two spectrum sensors 71, 72, and the spectrum sensor 71 detects the spectrum of the reflected light from the measuring object 15 irradiated with the ambient light 14. The data processing unit 51 captures the spectrum detected by the spectrum sensor 71 as the measuring object data 16 and stores the data in a predetermined region of the data storing unit 52.

The spectrum sensor 72 sets an area above the automobile 31 as the movable body as the detection range. FIG. 34(a) is a diagram showing an installation state and a part of the detection range of the spectrum sensor 72 and FIG. 34(b) is a diagram showing a part of the detection range of the spectrum sensor 72. As shown in FIG. 34(a), the spectrum sensor 72 in the twenty-second embodiment is installed at a ceiling outside of the automobile 31 so as to have the area above the automobile 31 as the detection range. A lens 95 for extending the detection range is provided at the spectrum sensor 72. The data processing unit 51 captures the light spectrum detected by the spectrum sensor 72 as the reference body data 18 and stores the data in a predetermined region of the data storing unit 52.

The spectrum acquiring device 11 in the twenty-second embodiment includes a position detecting device 102, a direction detecting device 105 and a date and time detecting device 108.

The position detecting device 102 is a device for detecting the current position of the automobile 31, such as an automobile navigation system. The data processing unit 51 captures the position detected by the position detecting device 102 as the current position of the automobile 31, generates position data 103 as data indicating the current position of the automobile 31, and stores the data in a predetermined region of the data storing unit 52.

The direction detecting device 105 is a device for detecting the current direction of the automobile 31, such as the automobile navigation system. The data processing unit 51 captures the direction of the automobile 31, which is detected by the direction detecting device 105, generates direction data 106 as data indicating the direction of the automobile 31, and stores the data in a predetermined region of the data storing unit 52.

The date and time detecting device 108 is a device for detecting the current date and time. The data processing unit 51 captures date and time detected by the date and time detecting device 108, generates date and time data 109 as data indicating the current date and time, and stores the data in a predetermined region of the data storing unit 52.

Then, the data processing unit 51 finds a detection position 110a of the sun 110 in the detection range of the spectrum sensor 72 from the position data 103, the direction data 106 and the date and time data 109. Then, the data processing unit 51, as shown in FIG. 34(b), generates detection position data 111 as data indicating the found detection position 110a and stores the data in a predetermined region of the data storing unit 52.

The data processing unit 51 acquires the light spectrum corresponding to the detection position 110a indicated by the detection position data 111 from the reference body data 18 on the basis of the reference body data 18 and the detection position data 111. The data processing unit 51 captures the acquired spectrum as the spectrum of the ambient light 14 from the reference body data 18, generates the ambient light data 19 as data indicating the spectrum of the ambient light 14, and stores the data in a predetermined region of the data storing unit 52.

For example, when a lot of roadside trees or buildings are provided in the periphery of the automobile 31, the light spectrum from the sun 110 is not necessarily detected at the detection position 110a indicated by the above-mentioned detection position data 111. Thus, in the twenty-second embodiment, the light source data 90 described in the twenty-first embodiment is stored in the storing unit 53 of the spectrum acquiring device 11. The spectrum of sunlight according to date and time is specified in the light source data 90. The data processing unit 51 reads the spectrum according to the current date and time of the automobile 31 from the light source data 90 on the basis of the date and time data 109 and compares the read spectrum with the spectrum indicated by the ambient light data 19. When the spectrum indicated by the ambient light data 19 satisfies the light source data 90, the data processing unit 51 outputs the measuring object data 16 and the ambient light data 19 to the spectrum converting device 12 (FIG. 1).

The data processing unit 21 of the spectrum converting device 12 stores the measuring object data 16 and the ambient light data 19, which are input from the spectrum acquiring device 11, in a predetermined region of the data storing unit 22. Then, the data processing unit 21 generates the measuring object reflectivity data 20 on the basis of the measuring object data 16 and the ambient light data 19, and outputs the generated data to the discrimination device 13 (FIG. 1).

As described above, the twenty-second embodiment can achieve following advantages.

(17) In the detection range of the spectrum sensor 72, the detection position 110a of the sun 110 as the light source for the ambient light 14 can be found and the spectrum at the detection position 110a can be detected as the spectrum of the ambient light 14. Thereby, the spectrum of the ambient light 14 can be directly acquired.

The twenty-second embodiment may be modified as follows.

In the twenty-second embodiment, the light spectrum of the sun 110 as the light source for the ambient light 14 is detected by use of the spectrum sensor 72 that sets the area above the automobile 31 as the detection range. Alternatively, in acquiring the ambient light data 19 indicating the light spectrum of the sun 110, the detection position 110a of the sun 110 in the detection range of the first spectrum sensor may be found without using the spectrum sensor 72, and when the detection position 110a is located in the detection range, the light spectrum of the sun 110 may be detected from the measuring object data 16.

The spectrum sensor 72 is installed at, for example, the roof on the exterior of the automobile 31 via a direction changing device capable of freely changing the direction of the spectrum sensor 72. Then, the position of the sun 110 with respect to the automobile 31 may be found on the basis of the position data 103, the direction data 106 and the date and time data 109, which are stored in the data storing unit 52, and the direction of the spectrum sensor 72 may be changed by control of the direction changing device by the spectrum acquiring device 11 so as to face the found position.

### Twenty-Third Embodiment

Next, a twenty-third embodiment of the movable body spectrum measuring apparatus according to the present invention will be described with reference to FIGS. 35 and 36. In the twenty-third embodiment, a case where ambient light applied to the measuring object depends on an illumination fixture or the like in the surrounding environment, for example, during movement of the movable body at night, is assumed.

As shown in FIG. 35, the spectrum acquiring device 11 in the twenty-third embodiment includes the spectrum sensor 71 for detecting a spectrum and the image sensor 72d that can acquire a visible image, an infrared image and the like, and these sensors are installed so as to have the same detection range.

Here, the spectrum sensor 71 detects the spectrum of the reflected light from the measuring object 15 irradiated with the ambient light 14, and the data processing unit 51 captures the spectrum detected at each position in the detection range by the spectrum sensor 71 as the measuring object data 16, and stores the data in a predetermined region of the data storing unit 52.

The image sensor 72d is a sensor for generating and outputting image data in the detection range, and the generated and output image data is captured into an image processor 120 in the spectrum acquiring device 11. On the basis of an image processing result of the image data, the image processor 120 discriminates an object located in the detection range, detects an object that emits light as the specified object that can act as the reference body 17 to become a light source, and detects an object that is detected in the detection range and can become a discriminating object by the spectrum sensor 71, such as a pedestrian. On the basis of the image processing result, the image processor 120 also detects a detection position of the object in the detection range of the spectrum sensor 71. Further, on the basis of the image processing result, the image processor 120 calculates the distance between the specified object that can act as the reference body 17 and the object that is detected in the detection range and can become a discriminating object, such as a pedestrian. The image processor 120 in the twenty-third embodiment, as shown in FIG. 36, detects a street light 121 and a signboard 122 having an illuminant as the reference bodies 17. As shown in the drawing, a pedestrian 123 is detected as the object that can become the discriminating object. Then, the pedestrian 123 is irradiated with light emitted by the street light 121 and light emitted by the signboard 122, that is, the pedestrian 123 is irradiated with synthetic light as the ambient light 14.

The image processor 120 generates detection data 124 as data indicating detection positions 121a, 122a in detection ranges in the street light 121 and the signboard 122 of the spectrum sensor 71 and distances L1, L2 between the street light 121, the signboard 122 and the pedestrian 123, respectively.

The data processing unit 51 of the spectrum acquiring device 11 captures the detection data 124 and stores the data in a predetermined region of the data storing unit 52. The data processing unit 51 detects spectrums S1, S2 as spectrums indicating the light intensity for each wavelength at the detection positions 121a, 122a of the measuring object data 16 on the basis of the measuring object data 16 and the detection data 124, generates the reference body data 18 as data obtained by associating the spectrums S1, S2 with the distances L1, L2, and stores the generated data in a predetermined region of the data storing unit 52. The data processing unit 51 outputs the measuring object data 16 and the reference body data 18 to the spectrum converting device 12 (FIG. 1).

The spectrum converting device 12 calculates the spectrum of the ambient light 14 applied to the object that can become the discriminating object. Describing in detail, the data processing unit 21 of the spectrum converting device 12 calculates the spectrum of the ambient light 14 applied to the pedestrian 123 on the basis of the reference body data 18 and the distances L1, L2 between the spectrums S1, S2 and the pedestrian 123 as the specified object that can become a discrimination object. That is, given that the light intensity at wavelength f of the ambient light 14 is λf, the spectrum of the ambient light 14 is calculated according to the following equation (3).

λf=S1×L2/(L1+L2)+S2×L1/(L1+L2) (3)

The data processing unit 21 generates the ambient light data 19 as data indicating the light spectrum thus calculated as the spectrum of the ambient light 14, and stores the data in a predetermined region of the data storing unit 22. The data processing unit 21 generates the measuring object reflectivity data 20 on the basis of the measuring object data 16 and the ambient light data 19, and stores the generated data in a predetermined region of the data storing unit 22. The spectrum converting device 12 outputs the measuring object reflectivity data 20 thus generated to the discrimination device 13.

As described above, the twenty-third embodiment can achieve following advantages.

(18) Even when the measuring object 15 is irradiated with a plurality of light beams as the ambient light 14, the spectrum of the ambient light 14 applied to the measuring object 15 can be calculated. Therefore, even at night, the discrimination accuracy of the measuring object 15 can be improved.

The twenty-third embodiment may be modified as follows.

In the twenty-third embodiment, by processing the image data acquired by the image sensor 72d, the detection position of the spectrum sensor 71 for the object that emits light and becomes the light source as the specified object that can act as the reference body 17, is detected and the distance between the object and the discriminating object is found. However, as long as the detection position of the spectrum sensor 71 for the object that emits light and becomes the light source as the specified object that can act as the reference body 17, can be detected and the distance between the object and the discriminating object can be found, other methods using, for example, a stereo camera or a radar may be adopted.

### Other Embodiments

In the above-described first to twenty-third embodiments, common changeable elements are as follows.

In the above-mentioned first to twenty-third embodiments, it is assumed that each time the measuring object 15 is discriminated, a proper light spectrum is detected from the reference body 17 and in each case, the spectrum of the ambient light 14 can be calculated. However, in fact, for example, in the eleventh embodiment, the spectrum relative to a wall of a building may be detected at the detection position, at which the spectrum relative to the sky is detected. In this manner, the case where the reference body 17 and the light spectrum from the reference body 17 are clearly improper is also assumed. However, unless the automobile 31 as the movable body enters a place such as a tunnel, it is rare that the spectrum of the ambient light 14 greatly changes in a short time. Thus, a region for storing data indicating at least the last spectrum of the reference body 17 may be provided in the data storing unit 52 of the spectrum acquiring device 11, and when the light spectrum from the reference body 17 is improper, the spectrum of the ambient light 14 may be calculated to generate the measuring object reflectivity data 20, using the spectrum of the reference body 17 stored in the region of the data storing unit 52 again. With such a configuration, even if an improper spectrum is detected as the light spectrum from the reference body 17, the discrimination accuracy of the measuring object 15 can be prevented from lowering. This can be also implemented by further providing a region for storing at least the last calculated spectrum of the ambient light 14 in the data storing unit 22 of the spectrum converting device 12.

Further, a region for storing at least the last calculated spectrum of the ambient light 14 may be provided in the data storing unit 22 of the spectrum converting device 12, the spectrum indicating an average value of the light intensity at each wavelength or a mode value of the light intensity at each wavelength of the spectrum of the ambient light 14 stored in the region of the data storing unit 22 and the newly-calculated spectrum of the ambient light 14 may be calculated, and the spectrum thus calculated may be set as the spectrum of the ambient light 14. By using the spectrum of the ambient light 14, divergence between the actual spectrum of the ambient light 14 and the spectrum of the ambient light 14 used to discriminate the measuring object 15 can be reduced. In other words, the discrimination accuracy of the measuring object 15 can be improved. This can be implemented also by providing a region for storing data indicating at least the last spectrum of the reference body 17 in the data storing unit 52 of the spectrum acquiring device 11 and calculating the spectrum indicating the average value of the light intensity at each wavelength or the mode value of the light intensity at each wavelength of the spectrum of the reference body 17.

The above-mentioned first to twenty-third embodiments can be appropriately implemented in combination. When the embodiments are combined with each other, there may be a case where a plurality of reference bodies 17 are set and the spectrum of the reflected light from the reference body 17 is detected for each reference body 17. In such case, the spectrum of the ambient light 14 may be calculated based on each of the spectrums of the reference bodies 17, and the spectrum indicating an average value of the light intensity at each wavelength or a mode value of the light intensity at each wavelength of the spectrums of the ambient light 14 may be set as the spectrum of the ambient light 14. With such a configuration, since the spectrum of the ambient light 14 is found based on the plurality of spectrums of the reference bodies 17, divergence between the actual spectrum of the ambient light 14 and the calculated spectrum of the ambient light 14 can be reduced. In other words, the discrimination accuracy of the measuring object 15 can be improved.

In the first to eleventh embodiments and the twenty-first embodiment, the detection range of the spectrum sensor 30 contains the front of the automobile 31 as the movable body. However, the detection range of the spectrum 30 may contain the rear of the automobile 31 or may contain sides of the automobile 31. Even with such a configuration, the discrimination accuracy of the measuring object 15 in each of the detection ranges of the spectrum sensor 30 can be improved.

In the twelfth to twentieth embodiments, and the twenty-second and twenty-third embodiments, the detection range of the spectrum sensor 71 as the first spectrum sensor may contain the front of the automobile 31 as the movable body. However, the detection range of the spectrum sensor 71 may contain the rear of the automobile 31 or may contain sides of the automobile 31. Even with such a configuration, the discrimination accuracy of the measuring object 15 in each of the detection ranges of the spectrum sensor 30 can be improved. According to each aspect, the detection range of the spectrum sensor 72 as the second spectrum sensor may be appropriately changed.

The above-mentioned movable body spectrum measuring apparatus may have the following functions. That is, the automobile 31 as the movable body is provided with an illuminant emitting light of a predetermined spectrum, and the illuminant is arranged so as to be contained in the detection range of the spectrum sensor. Then, according to a difference between an actual spectrum acquired at a detection position corresponding to the illuminant and the predetermined spectrum, a correction coefficient for making the actual spectrum close to the predetermined spectrum may be obtained, and the spectrum of the reflected light from the measuring object 15 or the reference body 17 may be corrected using the obtained correction coefficient.

In the above-mentioned movable body spectrum measuring apparatus, a hyper spectrum sensor having a wide imageable bandwidth and a high resolution of a few nm to a dozens of nm is used as the spectrum sensor. However, the spectrum sensor may be any sensor as long as it can acquire the spectrum of the reflected light from the measuring object 15 in the detection range, for example, a multi-spectrum sensor having 4 to 12 observation bands.

### DESCRIPTION OF REFERENCE NUMERALS

L1 . . . distance, L2 . . . distance, S1 . . . spectrum, S2 . . . spectrum, 10 . . . movable body spectrum measuring apparatus, 11 . . . spectrum acquiring device, 12 . . . spectrum converting device, 13 . . . discrimination device, 14 . . . ambient light, 15 . . . measuring object, 16 . . . measuring object data, 17 . . . reference body, 18 . . . reference body data, 19 . . . ambient light data, 20 . . . measuring object reflectivity data, 21 . . . data processing unit, 22 . . . data storing unit, 23 . . . storing unit, 24 . . . reference body reflectivity data, 25 . . . reflectivity dictionary, 29 . . . ambient light data, 30 . . . spectrum sensor, 31 . . . automobile, 32 . . . rear view mirror, 33 . . . hood, 35 . . . windshield, 36 . . . reflective member, 37 . . . mirror member, 39 . . . emblem, 41 . . . wiper, 45 . . . instrument panel, 51 . . . data processing unit, 52 . . . data storing unit, 53 . . . storing unit, 54 . . . reference body spectrum data, 55 . . . region data, 61 . . . traffic sign, 62 . . . traffic sign, 63 . . . traffic sign, 64 . . . road, 65 . . . sky, 71 . . . spectrum sensor, 72 . . . spectrum sensor, 72a . . . rear view camera, 72b . . . side camera, 72c . . . interior camera, 72d . . . image sensor, 74 . . . rear bumper, 75 . . . license plate, 76 . . . side mirror, 77 . . . door, 78 . . . reflective member, 79 . . . seat, 80 . . . provisional reference body data, 81 . . . road, 85 . . . image processor, 86 . . . detection position data, 90 . . . light source data, 91 . . . automobile, 92 . . . rear glass, 95 . . . lens, 99 . . . sphere, 102 . . . position detecting device, 103 . . . position data, 105 . . . detecting device, 106 . . . data, 108 . . . date and time detecting device, 110 . . . sun, 111 . . . detection position data, 120 . . . image processor, 121 . . . street light, 122 . . . signboard, 123 . . . pedestrian, 124 . . . detection data.

1. A movable body spectrum measuring apparatus comprising a spectrum sensor mounted on a movable body, the spectrum sensor being capable of dispersing observed light and measuring wavelength information and light intensity information that includes an invisible light region, the apparatus discriminating a measuring object around the movable body on the basis of a spectrum waveform constituted by the wavelength of the observed light and the intensity for each wavelength, the apparatus comprising:
a spectrum acquiring device for identifying a predetermined object with known optical characteristics from objects observed by the spectrum sensor, the spectrum acquiring device setting the identified object as a reference body; and
a spectrum converting device for converting the spectrum waveform of the measuring object into spectrum information used for discriminating the measuring object, on the basis of the spectrum waveform of the reference body and the known optical characteristics.

2. The movable body spectrum measuring apparatus according to claim 1, wherein the spectrum sensor is mounted such that at least a part of the movable body exists in a detection range of the measuring object.

3. The movable body spectrum measuring apparatus according to claim 2, wherein the movable body is an automobile, and the spectrum sensor is mounted at a rear view mirror of the automobile to face the front such that a part of a hood of the automobile exists in the detection range of the measuring object.

4. The movable body spectrum measuring apparatus according to claim 3, wherein
the spectrum acquiring device sets the hood as the reference body, and
the spectrum converting device previously stores the optical characteristics of paint on the hood and acquires spectrum information regarding ambient light applied to the measuring object on the bases of the spectrum wavelength of the hood and the optical characteristics.

5. The movable body spectrum measuring apparatus according to claim 2, wherein the movable body is an automobile, and the spectrum sensor is mounted at a rear view mirror of the automobile to face the front such that a reflective member provided on a part of a windshield of the automobile exists in the detection range of the measuring object.

6. The movable body spectrum measuring apparatus according to claim 5, wherein
the spectrum acquiring device sets the reflective member as the reference body, and
the spectrum converting device previously stores the optical characteristics of the reflective member and acquires spectrum information on ambient light applied to the measuring object on the bases of the spectrum wavelength of the reflective member and the optical characteristics.

7. The movable body spectrum measuring apparatus according to claim 2, wherein the movable body is an automobile, and the spectrum sensor is mounted at a rear view mirror of the automobile to face the front such that a part of a wiper of the automobile or a reflective member provided on a part of the wiper exists in the detection range of the measuring object.

8. The movable body spectrum measuring apparatus according to claim 7, wherein
the spectrum acquiring device sets the wiper or the reflective member as the reference body, and
the spectrum converting device previously stores the optical characteristics of the wiper or the reflective member and acquires spectrum information on ambient light applied to the measuring object on the bases of the spectrum wavelength of the wiper or the reflective member and the optical characteristics.

9. The movable body spectrum measuring apparatus according to claim 1, wherein the movable body is an automobile, and the reference body set by the spectrum acquiring device is a traffic sign.

10. The movable body spectrum measuring apparatus according to claim 9, wherein the spectrum converting device previously stores the optical characteristics of the traffic sign and acquires spectrum information on ambient light applied to the measuring object on the bases of the spectrum wavelength of the traffic sign and the optical characteristics.

11. The movable body spectrum measuring apparatus according to claim 1, wherein the movable body is an automobile, and the reference body set by the spectrum acquiring device is a road.

12. The movable body spectrum measuring apparatus according to claim 11, wherein the spectrum converting device previously stores the optical characteristics of the road and acquires spectrum information regarding ambient light applied to the measuring object on the bases of the spectrum wavelength of the road and the optical characteristics.

13. The movable body spectrum measuring apparatus according to claim 1, wherein
the spectrum sensor includes:
a first spectrum sensor for detecting a spectrum of the measuring object; and
a second spectrum sensor for detecting a spectrum of the reference body.

14. The movable body spectrum measuring apparatus according to claim 1, wherein the movable body is an automobile, and the reference body set by the spectrum acquiring device is a sky.

15. The movable body spectrum measuring apparatus according to claim 14, wherein the spectrum converting device previously stores data regarding a spectrum waveform of the sky and acquires spectrum information regarding ambient light applied to the measuring object, using the stored data as a reference.

16. The movable body spectrum measuring apparatus according to claim 14, wherein
the spectrum sensor includes:
a first spectrum sensor for detecting a spectrum of the measuring object; and
a second spectrum sensor for detecting a spectrum of the reference body.

17. The movable body spectrum measuring apparatus according to claim 1, wherein
the optical characteristics refer to information on a surface of the reference body, and
the spectrum converting device acquires spectrum information regarding the ambient light on the basis of the spectrum waveform of the reference body acquired by the spectrum acquiring device and known information regarding a surface of the reference body.

18. The movable body spectrum measuring apparatus according to claim 17, wherein
the information on a surface of the reference body is the surface reflectivity of the surface of the reference body, and
the spectrum converting device calculates the spectrum information on the ambient light by dividing the spectrum waveform acquired by the spectrum acquiring device by the surface reflectivity.
